(19) United States
(12) Patent Application Publication
(10) Pub. No.: US 2024/0331552 A1
(43) Pub. Date: Oct. 3, 2024

(54) DIGITAL FLIGHT AIRSPACE, CAPACITY, AND RISK MANAGEMENT SYSTEM AND METHOD

(71) Applicant: Airspeed Systems LLC, Chicago, IL (US)

(72) Inventor: Craig M. Watson, Chicago, IL (US)

(73) Assignee: Airspeed Systems LLC, Chicago, IL (US)

(21) Appl. No.: 18/619,571

(22) Filed: Mar. 28, 2024

Related U.S. Application Data
(60) Provisional application No. 63/492,539, filed on Mar. 28, 2023.

(51) Int. Cl. G08G 5/00; G06Q 50/40

(52) U.S. Cl. CPC G08G 5/0043; G06Q 50/40; G08G 5/0013; G08G 5/0026

(57) ABSTRACT

A Digital Flight Airspace Management System (DFAMS) and method for digitally managing the flight of a plurality of aircraft through a shared airspace. The system deploys digital airblocks dimensioned to safe separation standards by aircraft type and arrays them in a 3D lattice to represent any airspace. DFAMS authorizes flight plans in the form of accepting reservations for channels of contiguous airblocks between origin-destination pairs. Use of specifically dimensioned airblocks aligned in protected channels means accepted reservations are automatically safely-separated and deconflicted by design. Additional features support flight capacity management, DF risk management, differential aircraft performance and navigation capabilities, and cloud-based flight management systems.

### TECHNICAL FIELD

The disclosure relates generally to digital flight, and more particularly to a method and system for digitizing airspace, managing digital flight, providing flight capacity, and monitoring in-flight risks for aircraft in a shared airspace.

### BACKGROUND

Digital Flight generally refers to flight operations based on a combination of digital technologies and cooperative flight procedures. Operators (onboard pilots, remote pilots, and operators of pilotless drones) conduct flight operations though interaction with a digital information layer that takes the place of either Visual Flight Rules (VFR) or air traffic control (ATC) direction under Instrument Flight Rules (IFR). Cooperative practices avoid conflict and manage flight paths, while self-separation is supported by connected digital technologies and automated information exchange. According to NASA, “In digital flight, the aircraft operator uses automation to plan, monitor, evaluate, revise, and coordinate the aircraft's flight path within the operating environment. To perform these functions the automation must maintain or access a digital model of the operating environment, tailored to the aircraft's particular operation. Distributed and maintained by the operators and their service provider networks, each model consists of appropriately current information received from reliable, verified, and authorized sources . . . [including] weather, hazards, and constraints DFR operators are required to consider in their decision making.” The digital model is processable by automation, rather than human interpretation.

Digital Flight Rules (DFR) generally refer to the proposed set of operating procedures and capabilities supporting Digital Flight. The concept of operation anticipates that DFR's distributed, operator-managed capabilities will enable the airspace to accommodate and manage the vastly expanded volume and diversity of flight traffic expected in the future. Untethering flight from dependence on air traffic control is essential to accommodating this surge in the demand and diversity of aircraft. At the same time, DFR must enable seamless interaction with aircraft operating under VFR and IFR protocols.

Based on these design objectives, and supported by powerful digital technologies, individual operators will determine how to meet the customary requirements of air traffic management (ATM): safe separation from other flights, avoidance of conflicts in flight path planning, and safe management of air traffic flow—all without centralized direction or control we depend on today. These capabilities will in large measure be accomplished through a set of principles endorsing self-separation, cooperative conflict management, pair-wise separation, collaborative use of constrained resources, and self-organized management of constrained resources and associated complexities.

As these capabilities illustrate, digital flight as currently conceived is highly-dependent on distributed, individual operator decision-making, placing an enormous responsibility on individuals supported by automation, while providing limited oversight and regulatory coordination beyond that embedded approved system programming.

### SUMMARY

Disclosed is a system and method (a Digital Flight Airspace Management System, DFAMS) for managing airspace and flight plans by providing a digital model of shared airspace that automatically generates safely-separated and deconflicted flight paths on demand, relieving individual operators of this immediate burden. In an embodiment, the system leverages the same digital technology, national airspace capabilities, and third-party services envisioned in DFR, coordinating with them to offer available, safe flight paths that operators reserve with confidence and that remain protected while providing continuous state and condition data to operators along the entire route of flight.

Also disclosed is a system and method for managing digital flight capacity, wherein a range of capacity-adjusting methods is deployed in response to specific traffic conditions and aircraft navigation and operating performance capabilities.

Also disclosed is a system and method for monitoring digital flight risk management, wherein the indicators of safe separation and deconfliction are each visualized for a plurality of aircraft in a shared airspace, and providing alerts on an exception basis that works even among hundreds of concurrent flights.

In an embodiment, the disclosed system enables these capabilities by digitizing units of airspace dimensioned to altitude-dependent safe-separation parameters, and by aggregating these units into spatial arrays called lattices representing entire airspaces. Selected airblocks are connected in channels across the lattice to form flight paths that can be converted to safely-separated and deconflicted flight plans through a reservation process.

In an embodiment, the Digital Flight Airspace Management System is a data processing environment that establishes, operates, and maintains a digital embodiment of actual physical airspace. The system maps GPS coordinates and altitudes to units of airspace called airblocks, managing them as data records in a database that mirrors the meteorological conditions and flight activity in the corresponding physical airspace. It receives condition information (e.g., weather conditions, flight traffic, and navigational performance activity), assigns digital characteristics and conditions to airblocks, links airblocks to form flight path channels and performs all the data intake, computing, analysis, integration, and interpretation to produce the functional capabilities ascribed to the DFAMS flight environment. The DFAM system configures and/or manages collectively by way of a dashboard and/or administrative panel from which it controls the data and settings of system elements, including selecting airblocks, adjusting settings, modifying conditions, establishing thresholds, and setting other parameters to derive or impose desired results. In an embodiment, such DFAMS operations and management can also be executed automatically by a single central entity or by a collection of entities such as Providers of Services to UAMs (PSUs) and Supplemental Providers of Data Services (SPDS) similar to the current conception of DFR, and sharing a common operating picture (COP).

In this disclosure, wherever and whenever a system component such as an airblock or channel is described as performing an activity, it is understood that the actual actor is the DFAM integrated operating system, and the attributes and conditions reflected in the DFAM components such as airblocks and channels are those taking place in the actual physical airspace as in the case of weather, or in the activity of aircraft in the space, although such aircraft are represented digitally.

In an embodiment, the disclosed system includes the following features:
1. Airblocks. Units of airspace volume scaled to airspace-class-specific safe separation standards;
2. Lattice. An array of airblocks aggregated to form an entire designated airspace;
3. Channels. Contiguous airblocks within a lattice forming flight paths that are safely-separated based on airblock dimensions, and deconflicted by the act protecting a reserved channel from later occupation;
4. Reservations. The process of temporarily dedicating a designated channel to a specific flight plan;
5. Cross-flights. Flight paths that optimize available capacity by intersecting reserved channels at safe distances from channel traffic, and releasing the channel back to its original reservation;
6. Conflation. A method of compressing channels under certain circumstances to create additional safely-separated flight capacity;
7. Schedule Adherence. A risk management metric monitoring safe longitudinal deconfliction between leading and trailing aircraft in a channel; and
8. Channel Adherence. A risk management metric monitoring safe separation discipline within the lateral and vertical boundaries of a channel.
   These and additional features will now be more fully described.

(1) Airblocks. An airblock is a three-dimensional representation of a volume of airspace that has latitude, longitude, and altitude, can exist anywhere in an airspace, and is sized to the dimensions of the standard safe-separation spacing of an altitude class and corresponding aircraft type. In an embodiment, an airblock may have some or all of the following features:
a. An airblock is represented by a set of 8 GPS data points fixing the position in space of each corner of a rectangular solid (or rectangular prism), and located vertically by two additional dimensions of altitude fixing the position of the top and bottom planes of the rectangular solid. The difference between the top and bottom altitudes establishes the vertical distance inside the airblock.
b. An airblock is sized to replicate the 3D dimensions of the safe separation parameters of a specific class of airspace (a band of altitude in which specified aircraft are cleared to fly with designated spatial separation longitudinally, laterally, and vertically). For example, if a class of airspace (now or in the future) is designated to require 1-mile latitude and longitude safe separation from the nearest aircraft and 1,000 ft vertical separation, the airblock for that class has the same dimensions. In an embodiment, airblock dimensions may differ at different altitudes, aligned to airspace class and aircraft type performance requirements. As a result, in an embodiment, any aircraft occupying by itself an appropriately-sized airblock is safely separated from other aircraft by design.
c. In an embodiment, airblocks are created, dimensioned, and positioned by a Digital Flight Airspace Management System (DFAMS) which designates the 3D GPS position and altitude, computes and records the applicable data, configures the logic applicable to the airblocks in a designated space, and activates the information that runs the airblock's logic. This logic determines the rules that establish how conditions (e.g., weather and traffic) translate into states for the purpose of containing, directing, deterring, and/or managing air traffic inside or transiting through the airblock, and to eventually establishing if the airblock's status is available or unavailable for flight.
d. In an embodiment, DFAMS assigns conditions, logical functions, and rules to airblocks that also influence flight. For example, in an embodiment, DFAMS can set condition trigger alerts and notifications limiting the speed of an aircraft in the airblock. In an embodiment, and executing DFAMS conditional logic, an airblock may also show proximity warning indicators, and change the content of the information provided to aircraft in the airblock, or otherwise change the state of the airblock to respond appropriately to changing conditions.
e. In an embodiment, airblocks may also be subject to rules. For example, a sample rule is: No two aircraft can occupy the same airblock at the same time. Rules are fixed, prescribed responses to certain conditions such that in an embodiment certain conditions might direct aircraft to a different airblock, or communicate appropriate actions according to the state of the airblock, including setting the airblock's status to “unavailable.”
f. In an embodiment, airblock configuration refers to connecting the airblock to data sources about other aircraft, meteorological conditions, and other relevant information received by and processed in the DFAMS system and mapping them to airblock record data fields associated with the physical conditions present in the corresponding airspace.
g. In an embodiment, airblock activation refers to initiating the continuous receipt, processing, and communication of data the airblock is configured to receive. Accordingly, activation enables condition information to be processed into states that are then transmitted to or received by applicable aircraft approaching or interacting with the actual physical space represented by the airblock. DFAMS issues directives concerning aircraft speed and navigation in the airspace in response to airblock states, conditions, status, and the presence or proximate position of aircraft in contiguous airblocks.
h. Based on the data record representation of an airblock, the presence of an aircraft (or weather or other GPS-position-relevant entity or condition) within an airblock is identified by the extent to which its GPS and altitude data lie within the GPS/altitude-data-defined boundaries of the airblock. The DFAM system compares the GPS data of an aircraft to the GPS/altitude coordinates of airblocks to establish the presence and movement of aircraft in an airblock. It then uses changes in this information to determine how the aircraft is moving through the airblock, and correspondingly across the physical airspace, including computing the speed and bearing of the aircraft by measuring the change in its GPS/altitude location over time. In an embodiment, position data received from special systems, such as ADS-B equipment, LIDAR, or other sensors in existence or yet to be developed may be used interchangeably with GPS/altitude to establish position, altitude, vertical climb rate, etc.

(2) Lattice. A lattice is an ordered, three-dimensional array of airblocks representing an entire designated airspace. The arrangement of airblocks expresses the airspace across the measured span of its longitude, latitude, and altitude dimensions, including the variable separation spacing based on altitude-based classes of aircraft cleared to fly in the airspace. Lattices have specific properties:
a. In a lattice, airblocks are unique, non-overlapping 3-dimensional units of airspace assigned by GPS coordinates and altitudes to completely define the designated airspace. Each class-specific layer may contain a different number of airblocks with different dimensions as between layers, because airblocks at different levels may have different dimensions based on the airspace class represented. This conceptual airspace design is called a “block-lattice architecture.”
b. A lattice can define any given airspace by assigning full or partial arrays of airblocks to its complete coverage. Airblocks layered by class across an airspace may exist in multiple layers for the same class. Accordingly, if Class B airspace requires 1,000 ft vertical separation and exists between altitudes of 3,000 ft and 8,000 ft, then 5 layers of Class B Airblocks define the total Class B airspace.
c. A lattice (and thus the airspace it represents) can be managed as a database consisting of a repository of airblock data records. Correspondingly, in an embodiment, changes to the airspace are depicted through updates to the lattice-specific airblock data records, resulting in changes that can be communicated, accessed, read, and acted upon by aircraft systems, operators, and subscribers interacting with the airblocks in the context of the lattice.
d. In an embodiment, service providers and operators interact with a lattice through access to the relevant database supported by a communications and computing environment that is part of DFAMS capabilities.
e. In an embodiment, the DFAM system executes the following steps to completely express the block-lattice architecture of an airspace:
   i. Identify the outer GPS coordinates of the entire airspace defining a wall on each of the four sides and rising to the designated upper altitude of the space.
   ii. Determine the classes of aircraft in the designated airspace, and the altitude ranges applicable to each class.
   iii. Designate the dimensions that reflect the safe separation spacing applicable to each class, and assign these to altitude-specific airblock layers.
   iv. Beginning at the uppermost corner of the 3D airspace defined, generate airblocks at each class level moving from one end of the airspace to the other laterally and longitudinally until the entire class layer is filled. This is accomplished by adding to each longitudinal and lateral dimension of the first corner of the first airblock the GPS distance increment needed to define the airblock in both dimensions at a given altitude.
   v. Repeat for each altitude class layer until the entire airspace has been filled with class-specific layers of airblocks, which are by design already safely-spaced.
   vi. Apply the location coordinates of known obstructions (e.g., buildings, towers, etc.) and restrictions (e.g., military installations, power plants, etc.) over which flight is not permitted. Designate obstructed and restricted airspace as an applicable set of corresponding airblocks for which the designated status is “unavailable” for flight.
   vii. Implement this activity by adding the applicable number of airblock records to the database, ensuring that each relevant altitude layer is incremented by the appropriate GPS spacing, and then designating an airblock as available, obstructed, or restricted for flight, temporarily or permanently.
   g. Once every Airblock has been thus specified to cover the entire airspace, release the lattice to DFAMS to configure and activate each airblock with the relevant, conditional logic, functionality, rules, and data connections.

(3) Channels. A channel is a series of contiguous, lattice-specific airblocks connected to capture a unique, planned flight path. In an embodiment, the DFAM system constructs a channel in the following steps:
a. Specify the relevant airspace, aircraft, and class-specific altitude range, and desired timeframe applicable to the path.
b. Receive or identify a desired origin-destination pair or pairs, including applicable waypoints the aircraft will transit, and identifying a resulting “flight path.”
c. Map the flight path thus designated to the applicable airblocks in the airspace. Where there is discretion (i.e., where multiple airblocks might be available for such designation), select the airblocks that use the available airspace in the optimal manner based on at least one criterion of safety, duration, energy consumption, emissions reduction or other relevant factor (the ‘best path”).
d. For this best path, link the applicable airblocks in a sequence extending from the origin to the destination and including (by tracking to and from) applicable waypoints and any changes in altitude along the flight path and during the applicable time period of flight. The selected and linked airblocks form a channel.
e. Lock the series of airblocks in this channel (all with specific GPS, altitude, and time-related designations), and apply a unique identifier to the channel representing all of the connected airblocks incorporated.
f. Because channels represent connected airblocks of class-specific spacing, they already incorporate safe-separation. Accordingly, channels are, by extension, safely separated throughout their extent. This design feature is called “path-aligned separation” (PAS).
g. Because channels are dedicated to the unique flight for which they may be created, they are foreclosed to assignment to any other flight path. Accordingly, a channel is also deconflicted by design. This attribute is called “channel-based deconfliction” (CBD).
   In sum, and based on these factors, a channel is unique, defined by its airblock sequence, dedicated to a specific flight path, and automatically safely-separated and deconflicted.

(4) Flight Plan Reservations. In conventional aviation, an operator files a flight plan with a relevant aviation authority such as the FAA by phone or digitally, and waits for the flight plan to be accepted/confirmed. If another aircraft has also planned to be at the same place, altitude, and/or time at some point along the same flight path the plan is likely to be denied, and an alternate plan will need to be prepared and filed. Once accepted, the flight plan is confirmed by the authority to which it was submitted, indicating there are no known conflicts and adequate airspace and ATC capacity exists to add the flight to the specific origin-destination pair. Despite having been accepted, however, FAA confirmation only signals availability, but neither safe separation nor deconfliction along the flight path is assured. The accepted flight plan can become conflicted as more flights and intentions are entered into the system. The burden remains on the operators to continually confirm visually or through air traffic control, that the route is safely-separated and deconflicted in flight. This is done in advance through signaling intent, and contemporaneously through ATC direction.

By contrast, in an embodiment, filing a flight plan with the DFAM system is analogous to booking seats in a concert hall; seats are available or not, and meet certain minimum conditions of acceptability as a place from which to enjoy the performance. To illustrate in relation to flight, consider these specifications: identify the performance of interest (O-D pairing); specify the day (date); matinee or evening performance (time of day); the number in your party (aircraft class); whether you want seats in the orchestra, balcony, stage, or box (waypoints, alternate airfields, and related options). In an embodiment, DFAMS exposes as available flight paths that meet the requirements and these are offered for reservation. When the operator books the available flight plan option, the DFAMS system reserves the flight plan as a confirmed channel reservation composed of airspace-class-aligned airblocks connected across the designated O-D pair. The availability of a reservation confirms that it is safely-separated and deconflicted by way of the dimensions of the assigned Airblock at the relevant altitude, and by exclusion of all other air traffic along the course of the channel during relevant time periods. In an embodiment, the reservation information is available in DFAMS, because in the disclosed system, during the time before receiving a flight plan request, all existing flight and flight plan information has been “booked,” and only available, unobstructed, unrestricted, and now deconflicted airblocks are made available. Once selected, the available channel is reserved as a protected flight plan, and no longer available for reservation by another operator.

While channels are specific and removed from availability once reserved, multiple channels between O-D pairs can exist through staggered timing, different altitude availability, or other combinations that create additional unique and available channels.

In an embodiment, once the subject flight flying the reserved channel transits any of the series of connected airblocks that form the reserved channel, reserved airblocks are automatically released, becoming available for future flight plan demand. This ensures that flight capacity is not restricted for any longer than necessary.

(S) Cross-Flight. This process helps optimize air traffic flow by enabling reserved channels to be intersected (crossed) at safe distances ahead of oncoming reserved-channel aircraft. With this capability, the usable capacity of an airspace increases as reserved airspace can continue to be used to accommodate crossing flights. Flights only cross reserved channels, and do not occupy the same space at the same time. Once the reserved channel is safely crossed, the original reservation is re-established. In an embodiment of the DFAMS system, traffic volume and access are optimized by a continual process of reserving and releasing channels at any time and any applicable altitude tailored to the aircraft, its separation standards, and the specific requirements of the flight plan reservation and traffic volume. In every case, once a channel has been reserved, the top priority is to maintain the integrity of the reservation, its established safe separation standard, and the ongoing deconfliction of the route forward. In an embodiment, cross-flights are only permitted when these are not at risk, and for a very brief time period measured in minutes or less.

(6) Conflation. This is the ability to increase the flight volume capacity of a channel or group of channels by reducing their channel cross-section to the minimum necessary safe separation based on actual separation and on performance-based aircraft capabilities. Channel capacity is based on one aircraft per airblock, and thus one aircraft per connected or contiguous airblock channel. Because more than one channel can be applied to a given O-D pair, the collection of channels along an O-D pair represents more space than needed to maintain safe separation. This is because two channels side-by-side are both safely separated with respect to themselves, but have twice the separation needed when considered together; yet the channels continue to occupy non-overlapping space. Additional capacity can be created along a given flight path by “conflating” the channels together, moving them to overlapping positions that exactly bring each channel's carried aircraft into direct safe spacing with the aircraft in an adjacent channel. In a 9-channel set in an O-D pair, conflation narrows the original 9 channels to less space, resulting in freeing up channel capacity to accommodate an additional 16 aircraft in the outer ring released around the conflated original channels. Conflation nearly doubles the capacity of the zone or sector originally occupied by the first 9 channels. In an embodiment, conflation is implemented in a series of steps as follows:
a. Select the O-D pair
b. Aggregate available channels
c. Estimate demand volume
d. Consolidate channels in proximity to each other
e. Execute staged route expansion in a selected O-D pair based on flight volume demand
   i. Center-ring conflation eliminates duplicate spacing bringing all aircraft into one separation standard of each other at all times.
   ii. Traffic capacity expansion is then feasible providing for an orderly occupation of the space released through conflation.
   iii. Longitudinal conflation involves moving aircraft closer together as they fly in the same direction. Whenever this is feasible, it is accomplished by ensuring the distance between leading and trailing aircraft in a channel is reduced to the minimum standard.

(7) Schedule Adherence. DFAMS also provides a longitudinal display of the degree to which all aircraft in flight are on schedule as they proceed airblock-by-airblock along their channel-based flight paths. Flights that are ahead of schedule may pose a risk to flights in front of them, including cleared cross-flights. Similarly, flights that are behind schedule may pose a risk to trailing direct and cross-flights. Here again, attention only to exceptions (those flights too far ahead or behind schedule) is the basis on which deconfliction risk management across hundreds of concurrent flights becomes a feasible task.

(8) Channel Adherence. DFAMS provides a cross-sectional view of all channels combined to show which aircraft by exception may be veering too close to a channel wall—posing a risk to separation. This addresses lateral and vertical separation risks in the form of sideways and up/down movement within the channel. Attention only to exceptions (those flights at risk of breaching a channel wall) is the basis on which separation risk management across hundreds of concurrent flights becomes a feasible task.

In an embodiment, the features described enable DFAMS to manage air traffic flow in an airspace. Coordinating the progress of each flight in a plurality of occupied airblocks, reserving, locking, and releasing of airblocks on a just-in-time basis maximize availability of flight capacity while ensuring safe separation. Safe spacing across channels is a design feature that supports optimal aircraft flow through airblock signaling capabilities. If in an embodiment, airblocks are set to issue warnings, advisories, and speed directives, then together, entire airspace segments can be managed as to traffic volume and flow. Similarly, specific channels can be managed at the channel or airblock level. Conditional logic (“why” factors) and resulting impact (how much change where and to what intended effect) would only need to be programmed in DFAMS to deliver the desired effects, resulting in effective traffic flow management.

The DFAM system may in different embodiments draw from and integrate the disclosed features systematically to manage and optimize digital flight. The following features may be included as an integrated application or system of the disclosed concepts for (1) airspace digitization, (2) flight management, (3) autonomous flight management, (4) capacity management, and (5) risk management.

Airspace Digitization Method. In an embodiment, airspace digitization refers to a method for creating a digital representation of a physical airspace. The digital representation encompasses features of the physical airspace relevant to flight, enabling the establishment of an active digital platform for managing physical flight in the DFAMS environment. Method steps include:
1. Defining a unit of airspace as an airblock represented by an entry in a database and having fields including at least (i) spatial coordinates of the airblock; (ii) dimensions of the airblock based upon the safe separation parameters for a particular airspace class; (iii) conditions in the airblock including at least weather, air traffic volumes, aircraft types in flight, and corresponding navigation and performance capabilities of each aircraft type; (iv) obstructions and restrictions in the airblock related at least to no-fly zones and physical structures; (v) logic for processing condition data into the determination of an airblock state, and (vi) a resulting availability status of the airblock over time.
2. Mapping the database of airblocks to fully represent the spatial dimensions of the selected 3D physical airspace, resulting in a 3D digital lattice representation of the airspace.
3. Configuring airblocks to receive and utilize flight and condition data
4. Receiving data from multiple sources and feeds about conditions in the selected airspace, including at least weather, air traffic volumes, aircraft types in flight, and corresponding navigation and performance capabilities of each aircraft type.
5. Populating each airblock with at least the received condition data based at least on its specific spatial location in the airspace lattice.
6. Activating each airblock to process the received airblock flight and condition data
7. Determining the state of each airblock based at least on the status of condition, obstruction, and restriction data, and the corresponding ability of the airblock to safely sustain flight.
8. Establishing the availability of the airblock for flight as a function of state and time.

Digital Flight Management Method. In an embodiment, the Digital Flight Airspace Management System (DFAMS) manages the flight of an aircraft through a shared airspace from an origin to a destination, the aircraft being cleared for flight in a particular airspace class having predetermined safe separation parameters, the method comprising the steps:
1. Defining the digital airspace as outlined above
2. Maintaining an inventory of airblocks available to be deployed for flight in the digital airspace
3. Receiving from a user a request to reserve a flight plan for the aircraft from the origin to the destination for a specified timeframe, and in response thereto:
   a. identifying a flight channel of contiguous airblocks at specified altitude(s) within the airspace extending from the origin to the destination which (i) are available during the timeframe for the requested flight plan, and (ii) have permitted aircraft types that correspond to the aircraft,
   b. reserving for at least a portion of the flight plan timeframe, each of the airblocks comprising the identified flight channel by changing the availability status of each of the airblocks to unavailable during the relevant time of the flight plan,
   c. communicating to the user that requested flight plan has been reserved, together with information regarding the channel of airblocks for the flight, and
4. During the flight of the aircraft, continuously performing the following steps:
   a. receiving information regarding the position of the aircraft during the flight timeframe,
   b. comparing the current position of the aircraft to the position of the airblock corresponding to the relevant time of the flight,
   c. providing the aircraft updated information regarding whether the position of the aircraft corresponds to or deviates from the airblock corresponding to the relevant time of the flight.

Digital Autonomous Flight Management Method. A method for managing the flight of an autonomous air taxi through a shared airspace from an origin to a destination, the air taxi having predetermined safe separation parameters, the method comprising the steps:
1. Defining the airspace as outlined earlier with dimensions of the airblock based upon the safe separation parameters for the air taxi.
2. Identifying a flight plan for the air taxi from the origin to the destination for a specified timeframe.
3. Identifying a flight channel of contiguous airblocks within the airspace extending from the origin to the destination having a status of “available” during the timeframe for flight plan.
4. Changing the status to “unavailable” for each of the airblocks comprising the identified flight channel during the relevant time of the flight plan.
5. Supplying the air taxi with the identified flight plan and the identified flight channel including the reserved set of airblocks comprising the flight channel.
6. During the flight of the air taxi, continuously monitoring the current position of the air taxi with respect to the airblock reserved for the air taxi during the relevant time of the flight.
7. If the current position of the air taxi differs from the position of the reserved airblock during the relevant time of the flight, identifying an updated flight channel from the current position of the air taxi to the destination, and supplying the air taxi with the updated flight channel information.

Digital Flight Capacity Management Method. In an embodiment, the DFAM system and method for managing airspace capacity responds to demand and aircraft performance and navigation factors. It enables a system and method for managing the flight traffic capacity of a shared airspace containing flights between an origin and a destination, the flight environment being digitally represented by channels connecting contiguous GPS/altitude-defined, 3D airblocks representing the physical airspace and assigned corresponding predetermined safe separation parameters. The method involves:
1. Evaluating the context of capacity needs, whether enroute in a track or information region between airports, an airport capacity challenge in which there may be a combination of IFR VFR and DFR flights to manage, or a vertiport including a range of autonomous and air taxi vehicles.
2. Understanding of the scope and drivers of capacity management, including whether an entire airspace with multiple destinations is encompassed or a single origin destination pair; aircraft type, priority, and whether autonomous aircraft without pilots on board are involved; and finally, capacity management is also affected by traffic weather and safety considerations.
3. Balancing the supply of and demand for capacity, involves evaluating the mathematics of inbound demand evaluation, inbound capacity volume, the rate of absorption and the specific cadence of moving traffic through the airspace or onto an airport. These considerations are customary in air traffic capacity management, and not specific to DFAMS. However, DFAMS' ability to manage differential navigation and operating performance and to perform directed flight through advisories and notifications can be advantageous in certain capacity management situations.
4. Deciding to provide additional capacity or not. If affirmative, then capacity provisioning is triggered, and DFAMS selects the capacity method most appropriate to the conditions: cross-flight expansion, channel conflation, or metering and sequencing of traffic to match absorption capability and to prioritize aircraft with higher operating or navigation capabilities.

Digital Flight Risk Management Method. In an embodiment, DFAMS also enables high-level exception-based risk management. The method involves mitigating in-flight risks by visualizing data related to potential separation and conflict risks. Given that flight plans reflect “path-aligned separation” and “channel-based deconfliction,” the approach to risk management is based pragmatically on visualizing on a display adherence to these parameters across the airspace. Displays show the relative positions of a plurality of aircraft in their channels as a measure of separation risk, and visualize relative schedule adherence as a conflict measure capturing whether flights may get ahead or behind schedule, and thus threaten to conflict with forward or trailing aircraft on the same route. These risk metrics are especially valuable as conventional DFR has no means for the FAA to monitor actual digital flight activity for compliance with standards, even those embedded in system software. In summary, in an embodiment, the risk management method involves the following steps:
1. Receiving schedule, channel, and flight-specific position and condition information on a continuous basis from established sources such as the National Airspace System (NAS) and the planned third-party service providers to UAMs.
2. Visualizing the degree of channel adherence reflecting separation risks by generating a consolidated view of the cross-sections of all active channels. Flights outside a nominal channel ring pose risks that can be identified and contained with adequate notice and signaling capability embodied in DFAMS.
3. Visualizing the longitudinal conflict risk by generating a consolidated view of schedule adherence; the degree of alignment between planned and actual percent-completion of scheduled flights. Flights that are behind schedule are shown above the alignment vector, and those ahead of schedule are posted below the alignment vector. Any deviations of a significant nature pose a risk to flights ahead or behind the deviating aircraft, creating a conflict risk that can be identified and flagged across all the flights in the subject airspace by managing exceptions above or below a certain designated threshold.
4. Detecting and prioritizing channel-adherence and schedule-adherence risks across all flights in the airspace.
5. Capturing, for high-risk flight situations, the specific aircraft involved using a DFAMS interaction table that matches all flights on a matrix able to reflect all combinations of aircraft interactions, and delineate the nature of the risk by showing separation incidents on one half of the table and conflict risks on the other half, and creating time-dependent visual frames depicting these interactions.
6. Generating a risk-specific warning or alert transmitted to at least one of the interacting aircraft based on its airblock location and risk status, and tracking resolution.

### BRIEF DESCRIPTION OF THE DRAWINGS

The disclosed embodiments may be understood from the following detailed description in conjunction with the accompanying drawings of which:

FIG. 1 is a flow diagram showing the overall components of the digital flight airspace management system (DFAMS), including airspace digitization, flight planning, flight management, capacity management, and risk management.

FIG. 2 shows the DFAMS communication architecture used for gathering and processing inputs used to create the digitized airspace.

FIG. 3 illustrates an embodiment of the computer system, operating environment, and implementation of the Digital Flight Airspace, Capacity, and Risk Management systems.

FIG. 4 is a representation of the content and structure of an airblock, showing its dimensions and GPS position designations.

FIG. 5 shows how the dimensions of an airblock correspond to the safe separation dimensions around a representative aircraft or air taxi.

FIG. 6 shows in greater detail the composition of an airblock data record including GPS data and other elements.

FIG. 7 shows the block lattice airspace architecture with class layers, obstructions, restrictions, and the different block dimensions that exist at different class altitudes.

FIG. 8 is a flow diagram of the process for defining an airspace by its block lattice architecture according to an embodiment.

FIG. 9 is a flow diagram of the process for loading data to define the conditions that exist in the airspace according to an embodiment.

FIG. 10 identifies how an airblock is initially configured and then activated to deliver full functionality in the context of an embodiment.

FIG. 11 shows how airblocks are connected to create channels that sustain the safe separation spacing around and a representative aircraft traveling through the channel.

FIG. 12A illustrates how airblocks can be configured to capture the flight path of an aircraft that is ascending, cruising, and then descending.

FIG. 12B shows how blocks can be configured to capture the turning dimension of aircraft flight.

FIG. 12C shows how airblocks can represent combined movements including turns, tight turns and descending flight paths.

FIG. 13 illustrates the process of filing flight plans through a channel reservation process.

FIG. 14 identifies how the DFMS system and operators are updated in the process of enroute flights.

FIG. 15A shows the configuration of nine channels between the same origin destination pair, And the combined nominal space devoted to their safe separation.

FIG. 15B shows the usable airspace released during the process of conflation, which reduces airspace to the minimum separation required for all nine aircraft.

FIG. 15C identifies the additional 16 aircraft that can be accommodated from the airspace saved through conflation.

FIG. 16 identifies the directed flight control dimensions and effects that DFAMS can exercise within airblocks and channels to control the direction and spacing of aircraft.

FIG. 17 illustrates the airspace capacity management system made possible in the DFAMS environment.

FIG. 18 portrays safe separation risk in a specialized display that shows the degree of adherence to channel discipline among a plurality of aircraft in a representative environment.

FIG. 19 shows deconfliction risk using a specialized display demonstrating the degree of schedule adherence discipline among a plurality of flights, to identify which aircraft are trending ahead or behind schedule thus posing a risk to flights ahead or trailing.

FIG. 20 extends the information from the two prior displays showing specifically which two aircraft may be facing safe separation or deconfliction challenges.

FIG. 21 combines all three of the prior drawings, showing them in the context of the DFAMS risk management process that manages deconfliction and separation risk across an entire airspace with a plurality of aircraft.

### DETAILED DESCRIPTION

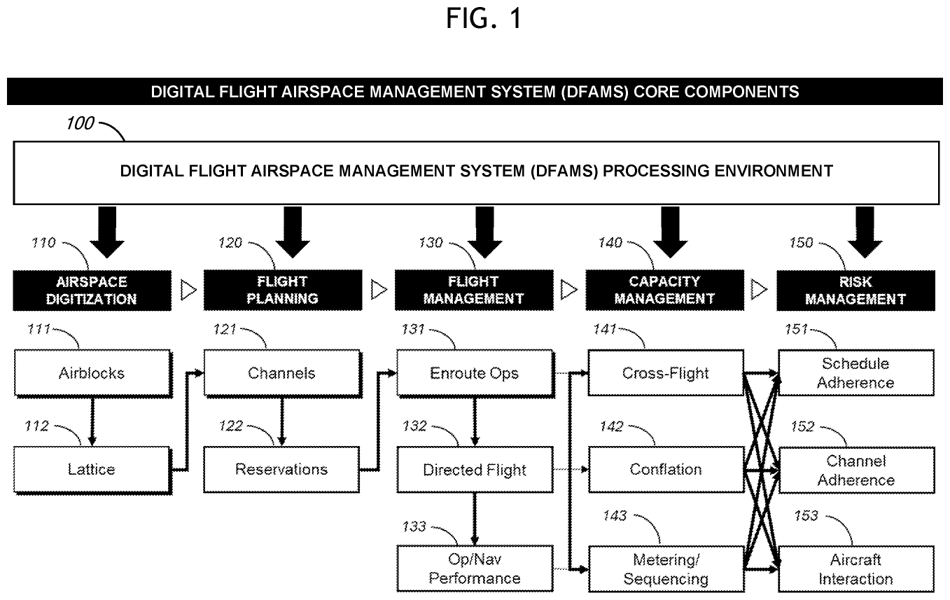

Turning to FIG. 1, a block diagram is shown representing components of the Digital Flight Airspace Management System. Taken together, these components enable every core aspect of Digital Flight without requiring air traffic control intervention or solely visual flight rule protocols. The system, in an embodiment, achieves this by deploying and managing the following components: DFAMS Processing Environment (DFAMSPE) 100 is a systems environment incorporating and integrating where needed the GPS navigation, altitude measurement, ADS-B communications, cloud connectivity, transponder communication, operational measurement (e.g., distance), weather, air traffic conditions, and other related or desired data sources attendant to achieving the designed management of the airspace, and either in existence or planned to support Digital Flight. The DFAMSPE executes all the computing needed to ensure the effective functioning of all components in the System. Airspace digitization 110, enables the digital representation of a physical airspace with sufficient functionality to be able to execute flight operations in the actual airspace. Flight planning 120 anticipates the need for flight plans to be filed by operators in order to operate in the physical airspace and, the corresponding digital airspace. Those flight plans are captured, adopted, confirmed, and retained in the DFAM system in the form of distinct and protected reservations. Flight management 130 addresses elements of flow and change encountered in real flight and correspondingly executed in the digital environment represented in this embodiment. These include enroute updating to operators, directed flight in which DFAMS guides aircraft to change direction, speed, or spacing to respond to operating constraints such as congested airport approaches. Capacity management 140 is an especially important element of airspace management, and is executed in DFAMS using a combination of measures to manage the available airspace for given volumes of flights. Risk management 150 in the embodiment is also tracked and enabled with specific reference to deconfliction by schedule oversight and safe separation through a channel adherence discipline.

Continuing with FIG. 1, each of the above components uses two or more key features in an embodiment that facilitate achievement achieve the goals of each component in the Digital Flight Airspace Management System: Airblocks 111, are the fundamental building blocks of airspace and have dimensions tied to safe separation distances in specific airspaces designated by altitude. For example, at 1200 feet altitude, an air taxi going from downtown to the airport would along every step of its journey occupy an airblock tailored to the safe spacing dimensions of air taxis in that altitude class. A designated airspace would in an embodiment be entirely represented by a combination of airblocks occupying every dimension of the airspace with safe separation parameters guided by the altitude classes in the airspace. The result is the complete translation of physical airspace into a corresponding digital version called a lattice 112. The airspace represented by this lattice can then be shaped to reflect obstructions, such as those encountered above power plants and buildings, and restrictions, such as those encountered above military bases. Accordingly, an entire airspace can digitally represent all of the features of the physical airspace including the airspace volume, different safe separation classes at different altitudes, and obstructions and restrictions that would apply.

The activity customarily known as filing a flight plan 120 is carried out in DFAMS in the context of channels 121. A channel is a series of contiguous airblocks that form a flight path from an origin to a destination. They can be of any reasonable length and shape that would represent the actual planned physical flight of the subject aircraft, including vertical takeoff and landing air taxis or drones. Every form of aviation with the exception of very small drones is captured and supported in the DFAMS environment. Flight planning is carried out by way of submitting a request to the DFAM System, and receiving a confirmed reservation 122. A reservation is, by definition, both safely separated (because of the airblock dimensions) and deconflicted, because the system will only compose channels that have no conflicts anywhere along their path the subject aircraft may be approaching. Note that once an aircraft has passed through an airblock that is part of its reserved channel, the airblock is immediately released from the reservation, and made available for other traffic. As a result of these features, the burden on pilots and operators to constantly bear the responsibility for establishing safe separation, and to plan over the course of the flight plan be accountable for deconfliction with other aircraft are both significantly reduced in the DFAMS environment. This safe separation and deconfliction are provided and available by design of airblocks, their contiguous linkage into channels, and the process of reserving airspace and enables the system to block potentially conflicting flights along the reserved flight path.

Once an aircraft is underway, flight management 130 is in effect, and may or may not be invoked by the system, depending on actual flight conditions. In an embodiment, an example of flight management would include receiving weather updates, traffic condition alerts, and indications of aerodrome or vertiport restrictions such that the operator might need to change the initial course of the flight. These data on conditions in any give an airblock specific to a reserved channel are constantly being updated during in-flight operations 131 based on information that exists today in the national airspace. Where there may be turbulence, overcrowding of channels, or other anomalies, the open and related information sources. The operator once notified may decide to change elements of the flight plan to adjust. In an embodiment the aircraft operator receives these data based on their airblock location, and with awareness of where the airblock is relative to the channel that has been reserved for the flight plan. Directed flight 132 is the ability of the DFAM system to coordinate messaging in any airblock or channel to direct aircraft to slow down, tighten spacing, or increase speed or adjust their sequence in response to specific traffic or capacity needs. An additional element of digital flight management involves taking account of the differential flight and navigation performance 133 of different aircraft. For example, an electric air taxi running low on battery power might be able to automatically be given landing preference. Additionally, an aircraft that is able to maneuver with exceptional control might be granted tighter safe separation distances than one that does not have this maneuvering capability. Recognizing and adjusting to these distinctions is one of the advantages and functional elements of digital flight.

Capacity management can encompass the overall volume of traffic in an airspace or sector of airspace, the traffic in a particular channel or flight path between and origin destination (O-D) pair, or the handling of aircraft in a nominal situation, such as landing, in which the cadence or sequence of aircraft management is a factor (e.g., where an aircraft needs to be prioritized for energy considerations, or wear a VTOL aircraft needs to suspend its approach to enable a fixed-wing emergency landing). The DFAMS approach to capacity management 140 is reflected in three features that are representative of how capacity might be managed in an embodiment. In order to optimize the use of airspace for flight plan efficiency or volume accommodation, Cross-flight 141 operations would be considered. A cross-flight is a flight that intercepts an existing reserved channel, using that airspace sufficiently far ahead of the aircraft using that Channel for it to be safely crossed. In such a situation a cleared cross-flight would be allowed to intersect the channel and continue on its way and the channel would be reconstituted to restore the original flight plan. Cross-flight would not be permitted if there is a proximate risk of conflict between two aircraft. As a capacity management method, cross-flights enable higher levels of safe airspace utilization.

An additional capacity management challenge concerns the volume of air traffic that can flow contemporaneously between an origin-destination pair. As each channel is planned, and more traffic is added, new channels are reserved, either at different altitudes or different times to accommodate as much traffic as possible in the O-D pair. Once the maximum number of channels has been reserved in this flight path, there is no alternative for increasing traffic but to reduce the cross section of the reserved channels, thus reducing the airspace the same traffic occupies. Each channel will have been reserved at a safe separation distance specific to its class. But this means that aircraft flying in two channels that are side by side (in other words, parallel channels) are twice as far apart as safe separation requires because each has been safely separated up to the boundary of its channel. Conflation 142 is the process of reducing the cross section of one or more channels so that this excess separation is minimized enabling additional traffic to be carried in this space released as the cross section is tightened. Conflation is a strategy that can be used in a flight information region across long distances, in short city pairs, and in approaches to vertiports and aerodromes. Conflation can also be used in combination with consideration of flight and navigation performance 133 factors. For example, high traffic volumes can be accommodated with conflation 10 miles from an airport and then different aircraft in conflated channels can be treated differently based on their maneuver or navigation capabilities.

In an embodiment, traffic can also be managed using techniques of metering and sequencing 143. These methods involve spacing aircraft and/or managing their arrival or departure timing in a target environment. Similarly, sequencing recognizes the potential to change the order of arriving or departing aircraft based on operational considerations or other reasons that might motivate a change in the order of operations. For all of these capacity management strategies, the DFAM PE manages, calculates or projects operations requirements.

The final component of the DFAM System concerns risk management 150. Deconfliction is achieved through the management of schedule adherence 151, a discipline in which the degree to which any reserved flight is behind on or ahead of schedule is measured with some precision. If a flight is ahead of schedule, even on a reserved channel, it runs the risk of intercepting a flight that was either planned as a cross-flight or might accidentally violate the reserved channel space. Conversely, when a flight is behind schedule the trailing airblocks of its reserved channel will not be released as early as the flight plan reservation had anticipated. This means that trailing flights run the risk of getting too close or that Cross-flights that had anticipated released airspace might now come into conflict with a channel that continues to be reserved. Accordingly, surveillance of schedule adherence is a proxy for the evolution and existence of conflict risks. When scheduled adherence is not maintained, a condition called longitudinal compression risk may exist between leading and trailing aircraft, regardless of which might be behind or ahead of schedule.

In an embodiment, safe separation in DFAMS is measured by the degree to which an aircraft remains within its reserved channel. Channel adherence 152 captures the potential for lateral and vertical drift that is a direct cause of safe separation violations. Note that the direction of flight is immaterial in relation to Channel adherence. Loss of channel adherence results in a risk event called channel breach.

Finally, the DFAM system combines in one indicator schedule and channel adherence in an indicator aircraft interaction 153. Aircraft interaction refers to the ability to identify the specific aircraft which may be involved in a separation or conflict situation. Longitudinal compression risk or channel breach risk become actionable when in a potentially crowded airspace environment, the most proximate, involved aircraft (two or more) can be identified specifically. This aircraft interaction 153 supports risk prioritization and eventual communication with one or more involved aircraft operators. Anticipation and communication in these situations enable timely intervention on a purely exception basis when an accident may be imminent, but at further distances than those addressed with traffic collision avoidance systems (TCAS). Accordingly, the direct intervention of air traffic control is replaced by a surveillance system that tracks the most imminent potential risks in as passive away as possible. We believe that in an embodiment this passive surveillance is by far preferable to the contemplated planned fully distributed, unmonitored DFR environment currently envisioned.

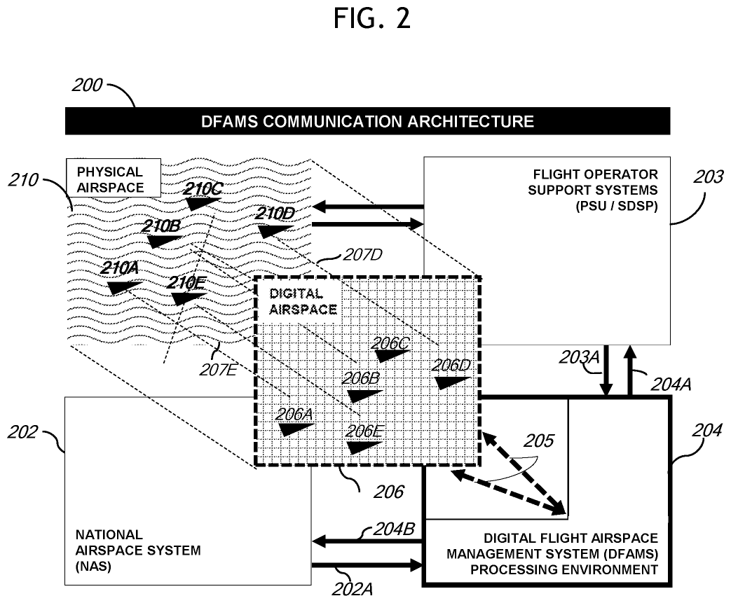

FIG. 2 addresses the DFAM Communication architecture 200, specifically, the linkages between DFAMS and its major data sources. The real physical airspace is represented in 210, and contains 5 representative aircraft, 210A, 210B, 210C, 210D, and 210E, which are flying real flight paths and missions in the subject airspace. Pursuant to the Concept of Operations guiding Urban Air Mobility, these vehicles and their operators are supported by a network of third-party operations called Providers of Services to UAMs (PSU) and supplemental data service providers (SDSPs) 203. Operators receive current condition information from the PSU, and the SDSP provides services such as environment, situational awareness, strategic operational demand, vertiport availability, and supplemental data. Services help operators determine their operational intent, route, estimated flight times, and related information to support communication about their cooperative flight responsibilities in distributed digital flight. These services also reflect the availability of substantial information to implement the disclosed DFAMS system. These sources share their information 203A with DFAMS 204, which could potentially exchange data with the PSU 204A in an embodiment to ensure synchronized data and maintenance of a Common Operating Picture (COP) that DFAMS could also build and maintain for all operators and services.

Further to FIG. 2, the existing National Airspace System 202 will continue to be a rich source of flight information, especially air navigation, weather services navigation aids and technical information such as aircraft performance capabilities. This information would be shared with DFAMS 202A, and any additional information DFAMS 204 might possess could in turn be shared with NAS 204B. Combined with GPS, altitude, ADS-B systems, and an evolving array of sensors and locational technologies, DFAMS would be well equipped to generate 205 a rich digital airspace, as well as digital representations of actual aircraft in-flight in the space 206A, 206B, 206C, 206D, and 206E. Accordingly, DFAMS generates digital data threads 205 that contain all the data needed to create a comprehensive digital airspace twin populated with digital versions of the actual relevant aircraft and capturing their flight operations.

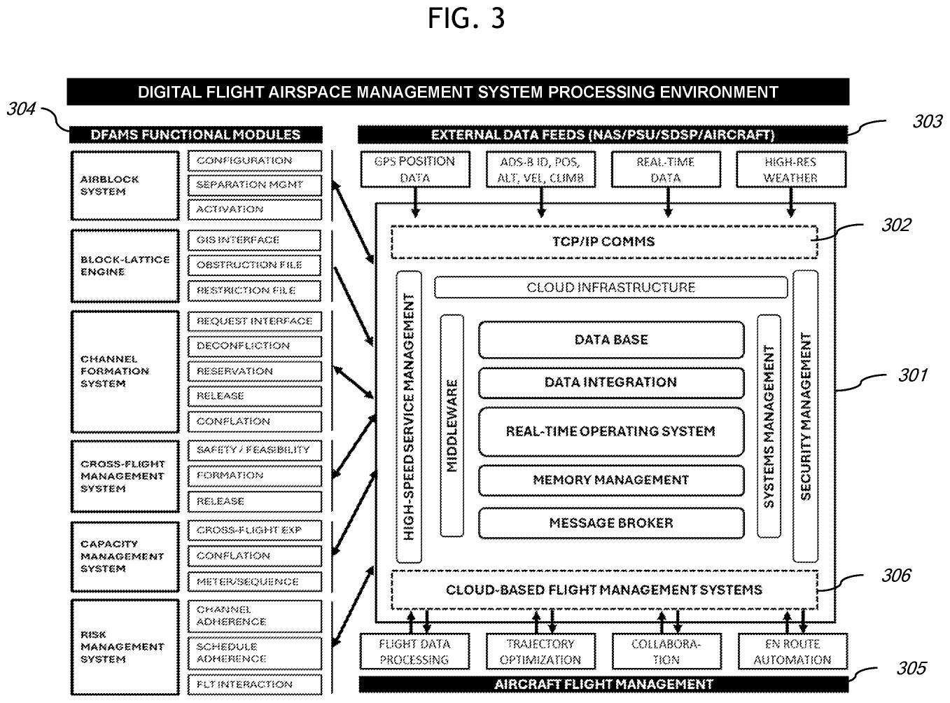

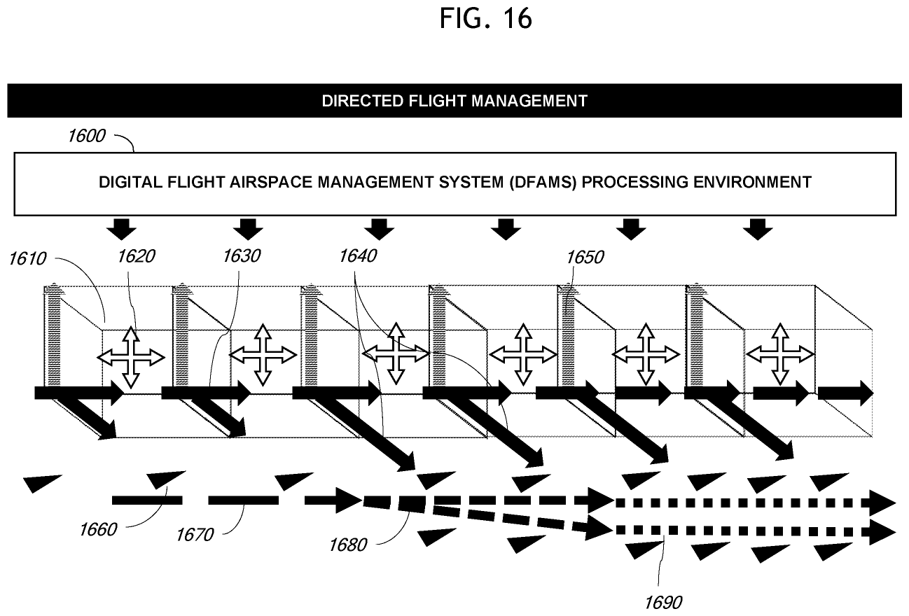

FIG. 3 illustrates, according to an embodiment, the hardware, software, interfaces and communication paths of a designed to implement the Digital Flight Airspace Management Systems Processing Environment. The environment includes of four components integrated to perform DFAMS functions for a plurality of aircraft in a shared airspace: In an embodiment, the core processing system 301 integrates the fundamental elements supporting high-speed processing, and communications across all the elements of the system. System 301 may be based on a cloud-based or on-premise Real-Time Operating System (RTOS) designed to manage high-speed transactions and data exchanges, including integrated data inputs, rapid memory exchanges, and messaging. Secure transmission over dedicated TCP/IP Internet protocols 302 are received from multiple external data sources 303. These represent highly granular and rich data feeds based on cloud and ground-based systems with far larger capacity, speed, and detail than can be received and processed by systems onboard aircraft. These sources include GPS position data; Automatic Dependent Surveillance-Broadcast (ADS-B) data provides aircraft identity, position, altitude, velocity, and rate of climb information essential to tracking aircraft in the airspace. Other real-time data from the National Airspace System is also received and processed in system 301 through the data communications channel 302. In an embodiment, the DFAMS-specific functional modules 304 embody the elements needed to execute airblock operations, block-lattice airspace architecture, channel formation and reservation, cross-flight management, capacity management, and risk management. Each of the modules 304 is called and interacts with the processing system 301 which integrates their functional operations into the overall system function to deliver DFAMS performance. Actual transmission of the resulting data and instructions to aircraft in the airspace is executed through communications to individual aircraft flight management systems 305 managed by operators, either onboard, remote, or autonomous. In the embodiment shown, cloud-based flight management system (FMS) 306 is shown because of its advanced ability to perform ground-side operations while providing a digital twin or replica of each aircraft's FMS. The system 301 and 306 combine their advanced processing capabilities and rich data exchange 303 and 302 to enable flight data processing, trajectory optimization, collaboration functions and en route automation that also supports DFAMS airblock-based directed flight capabilities cited in FIG. 16.

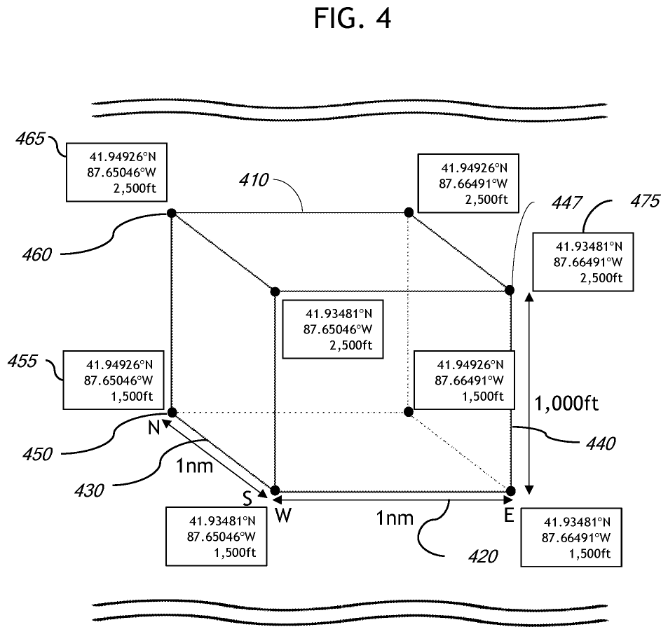

FIG. 4 shows the elements and spatial detail of a representative airblock 310. An airblock is represented by a set of 8 GPS data points demarcating the position in space of each corner of a 3D rectangular solid (or rectangular prism), and located vertically by two additional dimensions of altitude fixing the top and bottom planes of the rectangular solid. The difference between the top and bottom altitudes establishes the vertical distance inside the airblock and is always measured as aerial distance from the ground. The airblock is positioned in the selected airspace class according to the GPS-coordinate/altitude datapoints at each of the eight (8) vertices of the airblock. In this example, the airblock is 1 nautical mile wide 420, one nautical mile long 430, and 1000 feet in vertical distance 440. The airblock has eight corners representative of a rectangular solid shown, for example, at 450, 460, and 470. Each of these corners has a three-part location specification: GPS longitude, GPS latitude, and altitude, here shown at 455, 465, and 475, for the designated corner locations. Taken together, these location details uniquely specify the location in space and the airspace volume of the representative airblock.

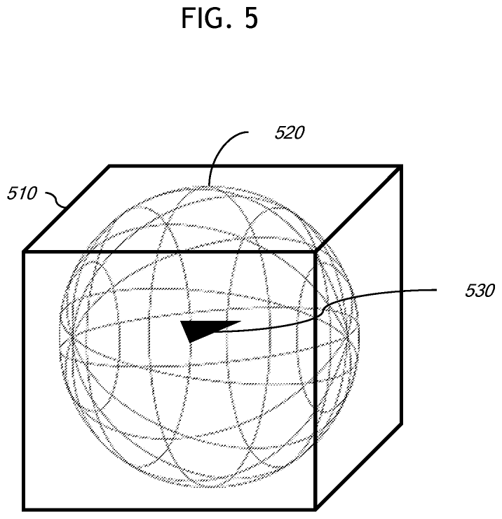

FIG. 5 illustrates how representative airblock 510 is scaled specifically to the dimensions of the safe separation parameters 520 surrounding air taxi 530. An airblock is sized to replicate the 3D dimensions of the safe separation parameters of a specific class of airspace (a band of altitude in which specified aircraft are cleared to fly with designated spatial separation longitudinally, laterally and vertically). For example, if a class of airspace (now or in the future) is designated to require 1-mile latitude and longitude safe separation from the nearest aircraft and 1,000 ft vertical separation, the airblock for that class has the same dimensions. In an embodiment, airblock dimensions may differ at different altitudes, aligned to aircraft class and performance requirements. As a result, in an embodiment, any aircraft occupying by itself an appropriately-sized airblock is safely separated from other aircraft by design.

This illustration shows a symmetrical separation volume, but the system can replicate in the safe separation space in all three dimensions, whether spheroid, ellipsoid, or rectangular solid. Similarly, any aircraft, whether fixed wing, rotating wing, air taxi, drone, or similar, can be accommodated as long as the spatial dimensions of its separation space are known. The purpose of matching the airblock dimensions to the safe separation parameters of a particular aircraft is to ensure, by design, that safe separation is established as soon as a specific aircraft occupies the designated airblock space, thus eliminating dependence on operator control and providing assurance of safe separation in the first instance.

Continuing with FIG. 5, note that the spatial separation dimensions can assume a variety of shapes, the airblock itself will always be a rectangular solid with vertical and horizontal dimensions designated to match as closely as possible the safe separation parameters. This enables the airblock to be arranged and arrayed with other airblocks in a way that completely specifies the target airspace. A collection of rectangular solid airblocks will always be able to be arranged to represent an entire airspace.

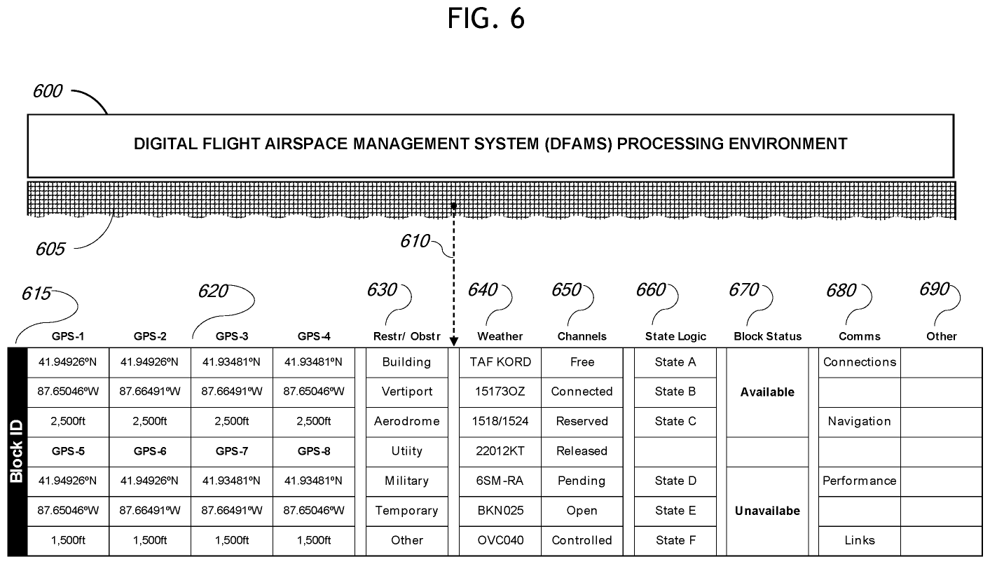

FIG. 6 illustrates in an embodiment of an airblock data record in the context of the digital flight airspace management system processing environment 600. The DFAMS manages hundreds of thousands of airblocks 605 in a given target airspace, and a representative single record 610 is shown. The sample airblock is identified by its block ID 615, and its location in space is specified by the 8 GPS and altitude indicators 620. Alternatively, the spatial location and volume in space of an airblock could also be specified by other parameters, such as, for example, the GPS and altitude coordinates of the center (centroid) of the airblock and its length, width and height dimensions. Column 630 contains the specifications for restrictions and obstructions in this space and the extent to which the airblock may contain any element of them, including buildings, various landing type facilities, utility, military and other designated spaces and whether restrictions are permanent or temporary. Weather is detailed in the next data column 640 using standard aviation weather references that would be recognized by operators, and specific to the airblock location. These terms, for example, refer to Terminal Aerodrome forecast codes. The airport forecast time periods wind temperature and velocity, visibility in statute miles rain conditions, cloud formations and conditions (e.g., overcast) at indicated altitudes.

Further to FIG. 6, column 650 designates representative information related to channels the airblock may be part of, including Reservation status, digital connections, and other potential indicators of channel involvement and conditions. Column 660 identifies the logic that DFAMS might apply based on channel, weather, and location information to determine the state that might result from these combined conditions. Examples of block states would include the combined effect of traffic and weather, the extent to which an existing reservation might be approaching release, and whether certain controls might be in place because of traffic, emergencies and other circumstances. DFAMS computing logic determines how the state of the block is determined based on these multiple source conditions. By extension, block status 670 reflects the extent to which the airblock is available or unavailable to flight as a result of the state it may be in pursuant to the indicated conditions. Finally, in this representative embodiment, column 680 contains information related to the communications and other features of this space linking it to other airblocks. Here, too, DFAMS logic mediates how airblocks work together in the context of traffic flow state conditions, and flight volume requirements of the airspace. Column 690 is left open, indicative of a range of information logic and connection requirements the airblock might need to accommodate in operation now or in the future.

In an embodiment, and based on the data record representation of an airblock, the presence of an aircraft (or any other GPS-position-relevant entity or condition) within an airblock is identified by the extent to which the GPS and altitude data of the aircraft lie within the GPS/altitude-data-defined boundaries of the airblock. The DFAM system compares the GPS/altitude data of an aircraft to the corresponding coordinates of airblocks in an airspace to establish the presence of the aircraft in an airblock. It then uses changes in this information to determine how the aircraft is moving through the airblock, and correspondingly across the physical airspace, including computing the speed and bearing of the aircraft by measuring the calculated change in its location over time.

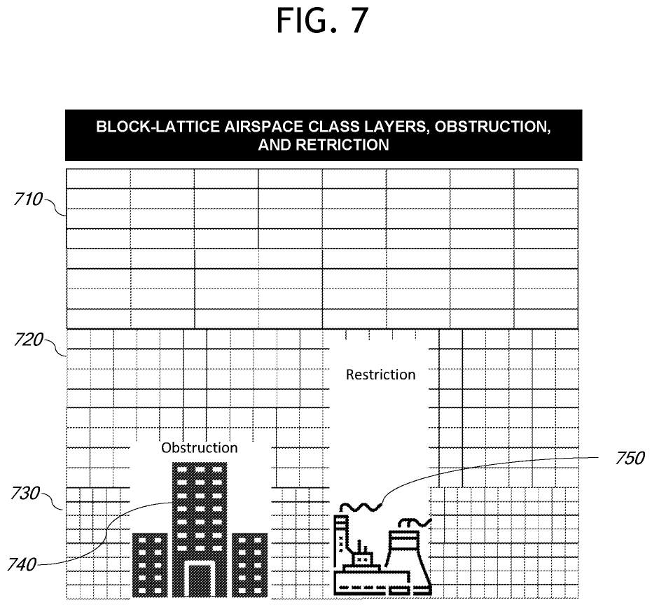

Turning to FIG. 7, the block lattice airspace is shown containing three different airspace class layers 710, 720, 730. These layers correspond at the upper most altitude to the largest airblock separation parameters. At lower altitudes the separation standards become smaller because air speeds are lower and maneuverability may be increased, consistent with the kinds of aircraft that operate in 720, such as air taxis. Shown is an overlay of obstructions and restrictions. Obstruction 740 represents tall buildings that penetrate 2 of the lower airspace class layers. There is an additional restriction above the utility plant represented by 750, and this extends to a higher level although still within the same airspace class layer 720. Similar restrictions might apply to military facilities and testing areas even if they do not involve relatively high structures. Restricted areas are no fly zones over expanses of geographic space.

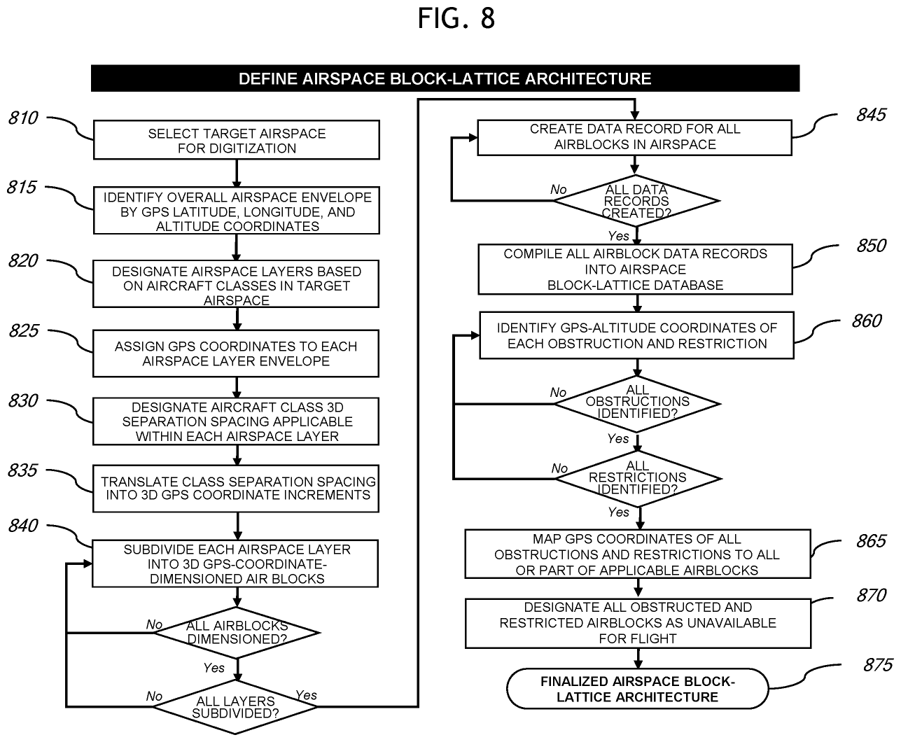

FIG. 8 represents the process by which an airspace is defined according to its block lattice architecture. In an embodiment, the following steps are involved: Step 810 involves selecting the target airspace for digitization. Step 815 identifies the overall envelope of airspace framed by GPS latitude, longitude, and altitude coordinates. The size and expanse of this space has no physical limits, but may have practical limits relative to administration of airspace utilization, metropolitan area locations, and other relevant factors. Once the airspace has thus been framed, step 820 designates the airspace layers airspace will be divided into to capture the aircraft classes that will fly in this space. In step 825, GPS coordinates are assigned to each airspace layer envelope over the entire expanse of the airspace at that level. Next, step 830 applies the three-dimensional separation spacing that applies to each class layer. The DFAM system, in step 835 translates the separation spacing at the given class layers into the three-dimensional coordinates that define each airblock. This step confirms the latitude and longitude spacing that applies across the class layer applicable to the altitudes represented in the airspace. This spacing is based on identified and accepted safe distances. In an embodiment, based on this information, step 840 applies the 3D GPS dash coordinate dimensions to the subdivision of the entire airspace into the applicable class layer airblocks with appropriate dimensions. DFAMS repeats this process until all airblocks have been dimensioned and assigned in the space.

Airspace has been divided into the appropriate class layers that will govern the separation standards applicable to the space at different altitudes and relative to obstructions and restrictions. In step 845, each airblock is assigned its own data record, and the process repeats until all airblocks have been assigned data records.

Next, step 850 compiles the individual airblock data records into the airspace block lattice database. This step creates a database that replicates the entire airspace by bringing together all airblocks in a common structure and relationship.

In step 860, all obstructions and restrictions are geolocated within the airspace, and GPS and altitude coordinates of each obstruction and restriction are specifically determined so that the exact location and dimensions of these limiting factors are all designated and assigned to their designated airblocks.

In step 865, the GPS and altitude coordinates of all obstructions and restrictions are mapped to all or part of the applicable airblocks in the airspace.

Continuing with FIG. 8, Step 870 designates all obstructed and restricted airblocks as having a status of being unavailable for flight.

Finally, Step 875 confirms finalization of the airspace block lattice architecture.

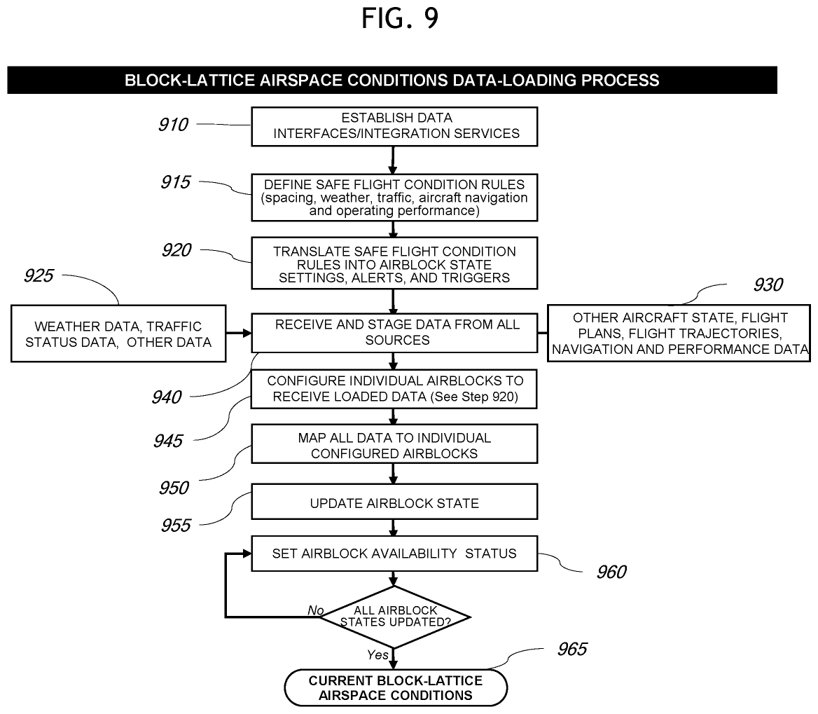

Next, FIG. 9 outlines the steps involved in loading data to the block lattice airspace database, beginning with step 910 establishing the interfaces and integration services involved in connecting data sources to the database to undertake the loading process. The creation of the lattice as an assembly of airblocks enables their management as a system, responding to conditions and determining states. Airblocks do not become “active” outside of the lattice context.

Step 915 defines the relevant safe flight condition rules that govern spacing, weather, traffic, aircraft navigation, and operating performance that will factor into the logic and calculations that determine the state and status of the airblocks in the lattice.

These condition data and rules are then translated in step 920 into the settings, alerts, and triggers that will apply to the individual airblocks across the lattice. The steps to this point have prepared the lattice and its component airblocks to receive, appropriately organize, and use information to be received in the steps that follow.

Step 925 identifies inbound weather data, traffic status data, and other flight environment information relevant to safe and informed flight.

Similarly, in step 930, data concerning other aircraft states, flight plans, trajectories, and navigation and operating performance data are loaded to the lattice database by this step.

Step 940 identifies the receipt and staging of data from all sources immediately prior to assignment to individual data blocks. In this stage, any necessary extraction, transformation, and loading processes can take place in preparation for the next step, configuration.

Step 945 ensures all airblocks are properly configured to receive data the block lattice airspace is receiving and that will be assigned to individual airblocks. Configuration is addressed specifically in FIG. 9.

Step 950 maps all the accumulated data to individual, configured airblocks.

Step 955 continuously updates the airblock state as new data is received and processed in the lattice. As a result, the combined impact of received weather, traffic, and other condition data, will determine each airblock's “state.”

Step 960 interprets the relevant state level to assess the overall airblock availability for flight (its status), accomplishing this across all airblocks in the lattice until data has been loaded to all applicable airblocks and completed in step 865.

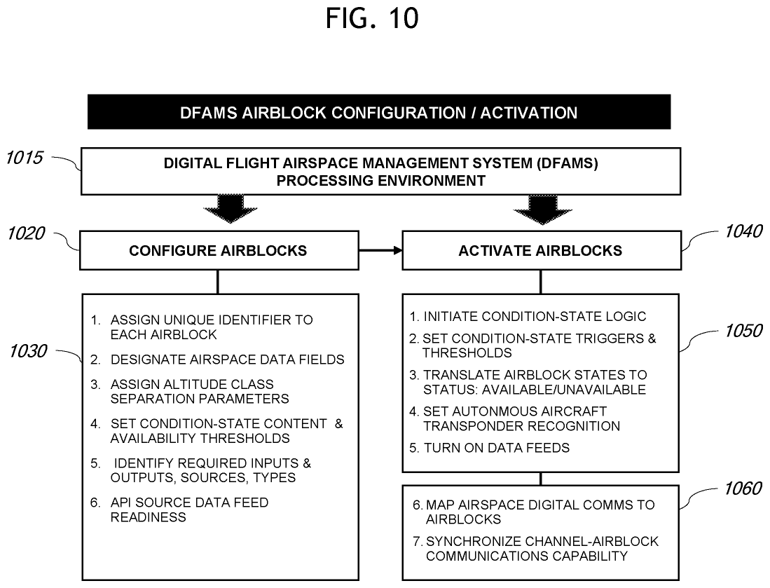

Next, FIG. 10 shows the key elements of configuring and activating airblocks. In step 1015, the DFAMS processing environment executes configuration and activation across applicable airblocks.

In an embodiment, airblock configuration refers to connecting data sources about other aircraft, meteorological conditions, and other relevant information from the DFAMS system and mapping them to airblock datapoints associated with the physical conditions present in the corresponding airspace.

Step 1020, configuration, involves the organization and readiness of airblocks to receive, process, and connect data in ways that enable the airblock data record to perform its function in the context of DFAMS processing.

Step 1030 identifies a selection of tasks addressed in the configuration process. These actions include assigning unique identifiers, designating data fields in the database, assigning separation parameters by altitude class, setting condition state content and the threshold conditions that determine availability or unavailability of the airspace for flight. Further, configuration involves identifying the required inputs outputs, data sources, and data types that airblocks are expected to process, and finally, ensuring readiness to receive appropriate live data feeds.

In an embodiment, DFAMS assigns conditions, logical functions, and rules to airblocks in the context of the lattice of which they are a part, resulting in states that respond to those conditions in ways defined by the functions and rules. For example, in an embodiment, DFAMS can set a meteorological threshold value such that certain received or computed weather conditions trigger alerts and notifications. An airblock may be set to dictate that the speed of an aircraft in the airblock be constrained. In an embodiment, and executing DFAMS conditional logic, an airblock may also show proximity warning indicators such that flights which DFAMS calculates are approaching the airblock may, under specified circumstances, issue warnings, change the content of the information provided to aircraft in the airblock, or otherwise change the state of the airblock to respond appropriately to conditions.

In an embodiment, airblocks may also be subject to rules. For example, a sample rule is: No two aircraft can occupy the same airblock at the same time. Rules are fixed, prescribed responses to certain conditions such that in an embodiment certain conditions might result in closure of an airblock to flight, direct aircraft to a different airblock, or otherwise signal or communicate appropriate actions according to the “state” of the airblock.

Further to FIG. 10, the activation process 1040 details how airblocks continue their development, moving from configuration to activation. After configuration and connection to the appropriate live data sources, activation means turning on the active processes in the DFAM processing environment to fulfill DFAM airspace airblock management tasks.

Activation includes the tasks in 1050, initiating the condition and state logic, setting appropriate triggers and thresholds for the logic, translating airblock states to the status of available or unavailable, setting special recognition parameters for autonomous aircraft in the airspace in case they require specialized connectivity and communication in the absence of an onboard operator, and finally, turning on the data feeds.

Insofar as airblocks are combined to form channels and may otherwise carry information that communicates with aircraft within their boundaries, activation also includes 1060 the mapping of airspace digital communications and the synchronization of how channels and airblocks work together through a joint transmission capability, and coordination with DFAMS processes governing the proper function of channels.

In an embodiment, airblock activation refers to the continuous receipt, processing, and communication of all data the airblock is configured to receive, and calculating the logical results of functions based on these data. Accordingly, activation enables condition information to be processed into states that are then transmitted to or received by applicable aircraft approaching or interacting with the actual physical space represented by the Airblock. Based on Airblock conditions, state, and the presence or proximate position of aircraft, DFAMS may in an embodiment issue directives concerning aircraft speed and navigation in the airspace.

In summary, in an embodiment, airblocks are created, dimensioned, and positioned by a Digital Flight Airspace Management System (DFAMS) which designates the 3D position, computes and records the applicable data, configures the logic applicable to the airblock, and activates the information that establishes the airblock's condition, ascribes the rules that establish how conditions (e.g., weather and traffic) translate into states for the purpose of containing, directing, deterring, and/or managing air traffic inside or transiting through the airblock.

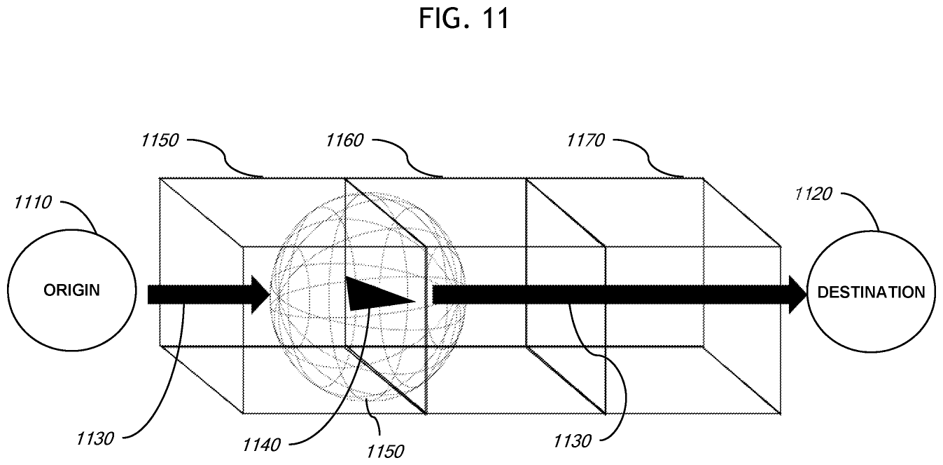

Turning to FIG. 11, the definition and creation of channels is addressed. A channel is a series of contiguous, lattice-specific airblocks connected to capture a unique, planned flight path. A channel begins with an origin 1110 and destination 1120 pair. Along a specified flight path 1130, a series of airblocks 1150, 1160, 1170 is linked to form a distinct connection between origin and destination. Blocks are connected end to end without overlapping, and because they are sized, by definition, to the safe separation standard 1150 of their airspace class, they are safely separated laterally and vertically along their entire path. Longitudinal separation is established according to rules, such that only one aircraft can occupy an airblock at the same time. The aircraft 1140 continues along this flight plan from origin to destination. As will be demonstrated in the next figure, these channels need not be straight paths. Along the flight path, as each airblock is exited by the aircraft, it is released and no longer reserved to the channel.

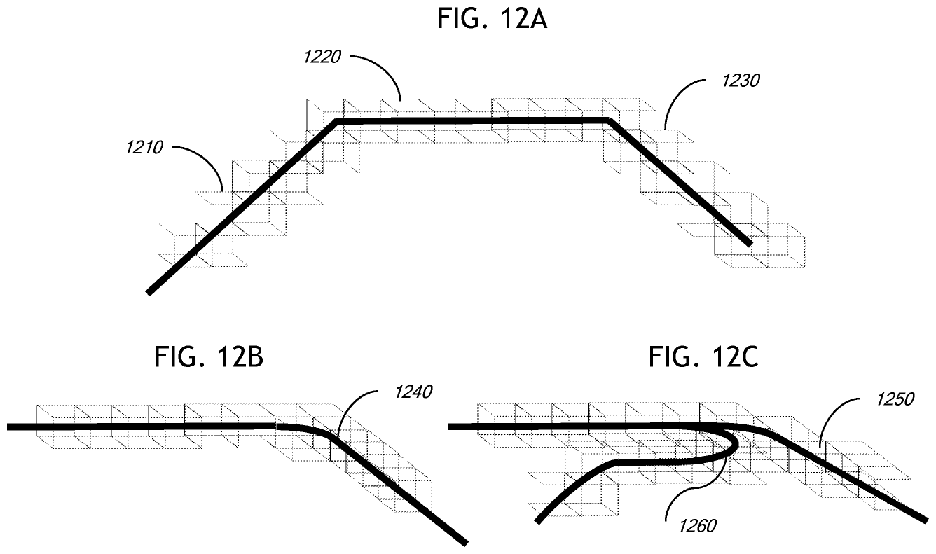

FIGS. 12A, 12B, and 12C demonstrate the ability of airblocks to accommodate the geometry of different flight paths. In FIG. 12A, ascending, level, and descending flights are shown in a continuous series of airblocks. In FIG. 12B, 1240 shows airblocks accommodating a sharp right turn. Finally, in FIG. 12C, turn 1250 moves across a series of airblocks, and a sharply reversing turn 1260 is equally accommodated by airblocks.

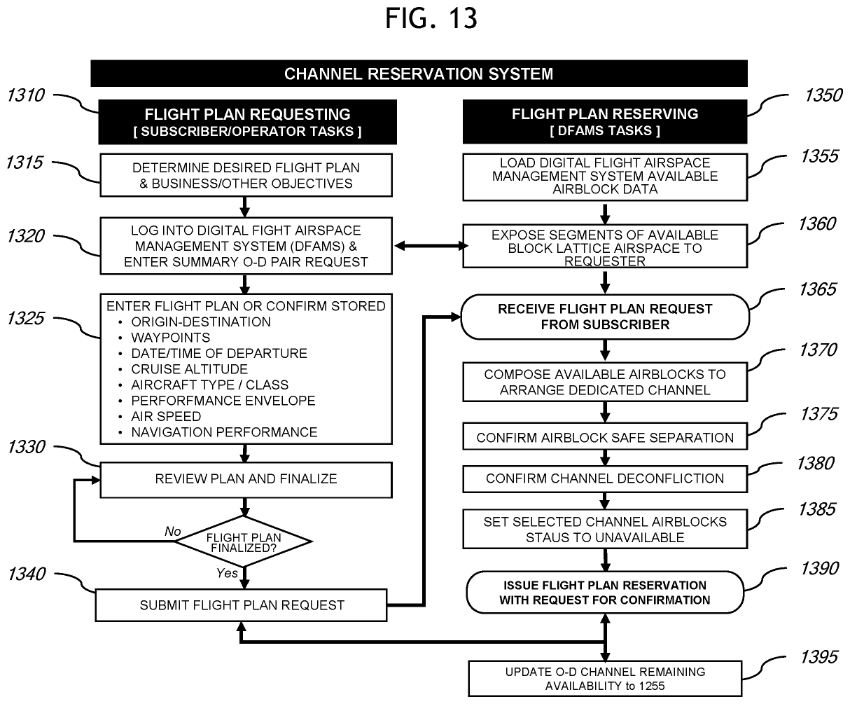

Next, FIG. 13 shows how DFAMS creates a channel in response to a request for a flight plan reservation. The distinguishing functionality of the DFAMS method is threefold: (a) requestors can see available pathways from the start, rather than submitting flight plans and waiting to see if they are accepted, (b) the requester submits a flight plan reservation request against what is already known to be open flight plan space—just like a theater goer would request an available seat, and (c) when the reservation comes back as confirmed, it is for a channel that is already safely separated and deconflicted. Because channels represent connected Airblocks of class-specific spacing, they already incorporate safe-separation. Accordingly, channels are, by extension, safely separated. We call this design feature “path-aligned separation” (PAS). Because channels are uniquely dedicated to the flight for which they may be created, and thus foreclosed to assignment to any other flight path, a channel is also deconflicted by design. We call this attribute, “channel-based deconfliction” (CBD).

Step 1310 begins the process with the requester starting the flight planning request with the decision about the desired flight plan followed by the step 1215 of logging into the DFAM system to enter an origin-destination pair request 1220. The DFAM reserving system 1350 will have a running inventory 1355 of available, unreserved space, so at step 1360 DFAM is able to expose high level segments of available block lattice airspace that is not yet reserved for other flights.

In step 1325 the requester details specific elements of the requested reservation, entering all of the same information that would be required in a conventional flight plan, reviewing and finalizing this plan at step 1330. In step 1240 the requester submits the final plan request.

The reserving system receives the flight plan request 1365, and proceeds to compose the available airblocks to form a dedicated channel 1370. This channel is confirmed to be safely separated 1375 based on the airblock dimensions for its airspace class designation. Once the channel is confirmed to be deconflicted in step 1380 along the entire pathway from origin to destination, the channel airblocks are then designated in step 1385 as unavailable for any other flight path reservation.

In step 1390, the flight plan reservation is issued with a request for confirmation by the requester, and the remaining O-D pair status is updated at step 1395 to prepare for other reservation requests. In sum, and based on these steps, a channel is defined by its sequence of connected airblocks, unique in that it is the only such channel to be reserved, deconflicted by reason of being reserved, and automatically safely separated because of the geometry of the airblocks of which the channel is composed.

While channels are specific and removed from availability once reserved, multiple channels between O-D pairs can exist through staggered timing, different altitude availability, or other combinations that render additional unique and available channels. In the concert analogy, seats in a box can continue to be booked until all seats in the box have been reserved.

In an embodiment, once the subject aircraft flying the reserved channel transits any of the series of connected airblocks that form the reserved channel, reserved airblocks are automatically released, becoming available for future flight plan demand. This ensures that flight capacity is not restricted for any longer than necessary.

In an embodiment, flight capacity is optimized by utilizing reserved channel space that can safely be made available to ahead of the reserved flight. This “cross-flight” capability helps optimize air traffic flow by enabling reserved channels to be intersected (crossed) at safe distances ahead of oncoming reserved-channel aircraft, rather than allowing the reservation to foreclose traffic along its entire length, including airspace that may not be occupied by the channel flight for hours. With this capability, the available capacity of an airspace increases since reserved airspace can continue to be used to accommodate safe crossing flights. Once the reserved channel is safely crossed, the original reservation is re-established. In the DFAMS system, traffic volume and access are optimized by a continual process of reserving and releasing channels at any time and any applicable altitude tailored to the aircraft, its separation standards, and the specific requirements of the flight plan reservation, so long as crossing happens at a safe distance from the aircraft with rights to the reserved channel. In every case, once a channel has been reserved, the top priority is to maintain the integrity of the reservation, its established safe separation standard, and the ongoing deconfliction of the route forward. In an embodiment, cross-flights are only permitted when these are not at risk, and for a very brief time period measured in minutes or less.

Cross-flights can be permitted if the ability to make the reservation shows the spacing between reserved and crossing flights to be safe; i.e., the distance between the aircraft in cross-flight at the intersection point is safely spaced from the aircraft in the channel being intersected at that point in time and space. Where cross-flight potential safely exists, DFAMS can:
a. Release the airblock in an intersected channel at the point of safe channel Intersection, allowing the cross-flight reservation to be established;
b. Monitor progress of all flights, estimating spacing at the projected point of intersection as both flights approach that point;
c. Track and confirm that the cross-flight intersection is completed safely;
d. Re-establish the original reservation once the cross-flight has passed.

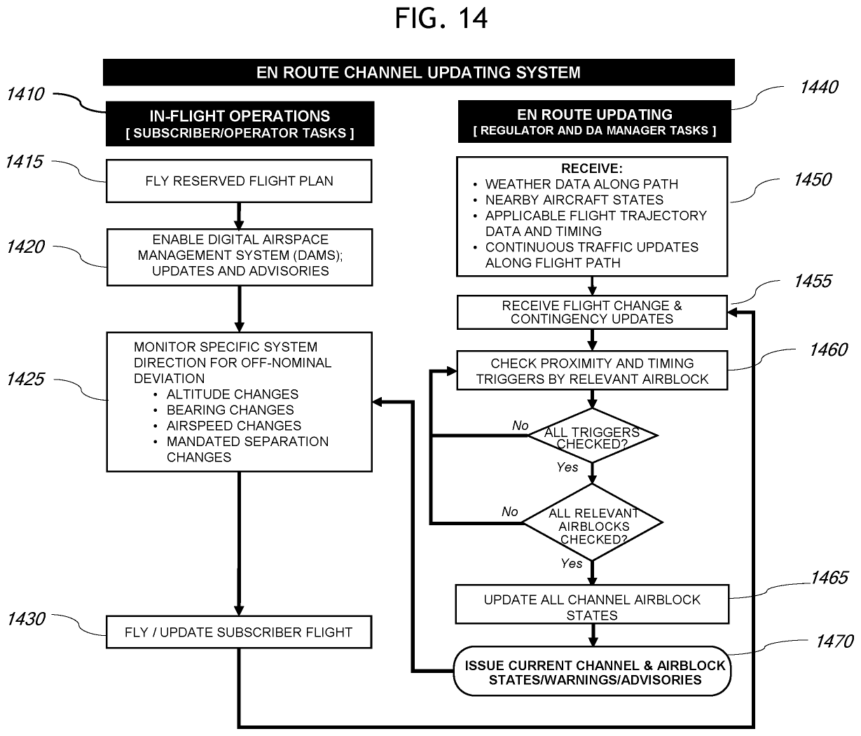

Turning now to FIG. 14, enroute updating of flight information is addressed by aligning in-flight operations 1410 to the enroute updating capability 1440 of the DFAMS system.

In steps 1415, the operator is flying a reserved flight plan, and monitors any potential incoming messages 1425 such as weather-related changes to speed, altitude, or bearing.

In step 1450, the DFAMS system processes incoming weather, traffic, delay, and off-nominal condition data that it translates into potential airblock state adjustments.

In addition, at step 1455, aircraft-specific flight changes and contingency actions are received and tracked, so that in step 1460 any implications for proximity or timing risks to other aircraft can be assessed across appropriate triggers and relevant airblocks.

In step 1465, based on the results of the above operations, impacted airblock states are updated and relevant advisories or other notifications are issued specific to airblocks, and received by aircraft in the particular airblock involved.

In step 1470, DFAMS issues new and specific updates directly to the airblocks involved, specifically notifying any aircraft in an affected airblock of the change or contingency relevant to that airblock.

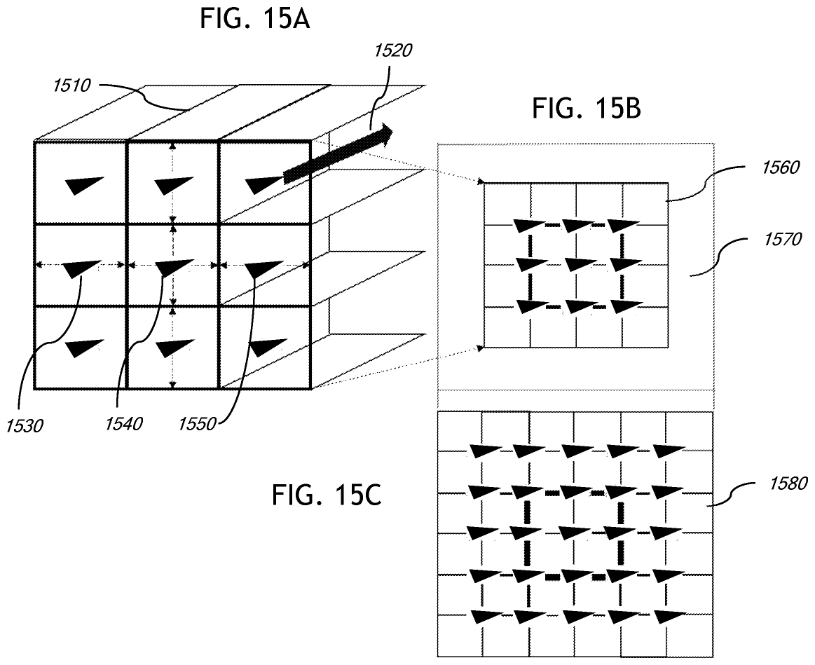

FIG. 15 further details the concept of conflation, a technique for maximizing the flight capacity of a set of reserved channels. This capability increases the flight volume capacity of a channel or group of channels by reducing their channel cross-section to the minimum necessary safe separation based on actual separation and on performance-based aircraft capabilities. Channel capacity is based on one aircraft per airblock, and thus one aircraft per multiple airblocks connected along a channel. Because more than one channel can be applied to a given O-D pair, the collection of channels along an O-D pair represents more space than needed to maintain safe separation. This is because two channels side-by-side are both safely separated within themselves, but as a result have twice the separation needed when considered together. Yet the channels continue to occupy non-overlapping space. Additional capacity can be created along a given flight path, by “conflating” the channels together, moving them to overlapping positions that exactly bring each channel's carried aircraft into direct safe spacing with the aircraft in an adjacent channel.

FIG. 15A illustrates a set of 9 adjacent channels 1510 in the same O-D pair heading in the direction of the arrow 1520. Because each is occupying its own safe space, the aircraft represented by 1530, 1540, and 1550 are twice as far from each other as needed to be safely-spaced. As a result, the channels can be conflated to half the cross-section of each, so each aircraft is at the edge of the safe separation distance. FIG. 15B shows that conflation narrows the original 9 channels to less space, 1560, resulting in freeing up flight capacity in the outer ring 1570 of the original 9 channels. By placing aircraft at the outer, safely-spaced edge of the original 9 aircraft, the same channel capacity can accommodate an additional 16 aircraft in the outer ring 1580 that is released around the conflated original channels, an increase of nearly twice the original number of aircraft. While the foregoing illustrates conflation in connection with aircraft traveling in the same direction, the same conflation process may be performed for aircraft that may be traveling in different directions in adjacent channels. In other words, the direction of the aircraft should be parallel, but need not necessarily all be in the same direction. As should be evident, the design of the digital airspace allows for nimble and flexible manipulation such as conflation. Complimentary to conflation, the flexible of the system may also be readily manipulation to perform a process of inflation, where spacing between aircraft, such as in parallel channels or otherwise, may be expanded or increased, such as in response to unexpected weather conditions where poor visibility may require greater spacing between aircraft.

In an embodiment following this example, conflation can be implemented in these steps:
a. Select O-D pair
b. Aggregate available channels
c. Estimate demand volume vs capacity
d. Consolidate channels in the closest available safe separation proximity
e. Execute staged route expansion in a selected O-D pair
   i. Center-ring conflation eliminates duplicate spacing, bringing all aircraft into one separation standard of each other at all times. This means that 9 aircraft originally occupying the space of 9 channels now occupy 50% of the space they occupied originally when their channels were managed individually.
   ii. The original spaces formerly occupied by the 9 aircraft are now available.
   iii. Traffic capacity expansion is then feasible providing for an orderly occupation of the space released through conflation.
f. Longitudinal conflation. Note also that there is the potential for longitudinal conflation, the closure of excess safe separation between aircraft in the direction of flight. This means that more aircraft can be moved closer together as they fly in the same direction. Whenever this is feasible, it is accomplished by minimizing the distance between leading and trailing aircraft in a channel is reduced to the minimum standard.

FIG. 16 depicts the multi-dimensional control the DFAM system can exert over aircraft in airblocks, enabling the system to take advantage of the differential operating and navigation performance of certain aircraft. DFAMS processing environment 1600 governs the execution of the guidance given to aircraft in its airblocks. In this example, the challenge is to optimize flow of more aircraft at slower speeds approaching an aerodrome. Aircraft with finer directional control at slower speeds, or with superior sensor capabilities able to hold station reliably for extended periods are favored in these situations compared to less capable aircraft. Subject only to energy limitations that might require less capable aircraft to land sooner, higher-performers can land at an accelerated pace, resulting in higher aerodrome landing capacity in the time allotted.

The following steps execute this example process: Channel 1610 contains a single aircraft per airblock, moving in the direction of flight 1630. Inside the airblock, aircraft can move in 4 directions indicated by the white cross 1620. DFAMS can direct aircraft to reduce or increase speed represented by the horizontal black arrows 1630. The shorter the arrow, the slower the directed speed. The diagonal arrows 1640 indicate the bearing the aircraft are directed to in order to have them fly in closer proximity and slower speed. Vector 1650 is dormant in this example, but would be used to move aircraft toward the top of the airblock where this movement is desired. At the initial entry into the approach formation, aircraft 1660 are both moving relatively fast 1670 and with wider distances between them. Deceleration begins at 1680, accompanied by aircraft moving into a dual vs single file arrangement as they approach the aerodrome. Further reductions and closer formations are achieved at 1690 as DFAMS directs the stream of aircraft gets close and the formation tightens for the aircraft that can sustain both position control and airspeed.

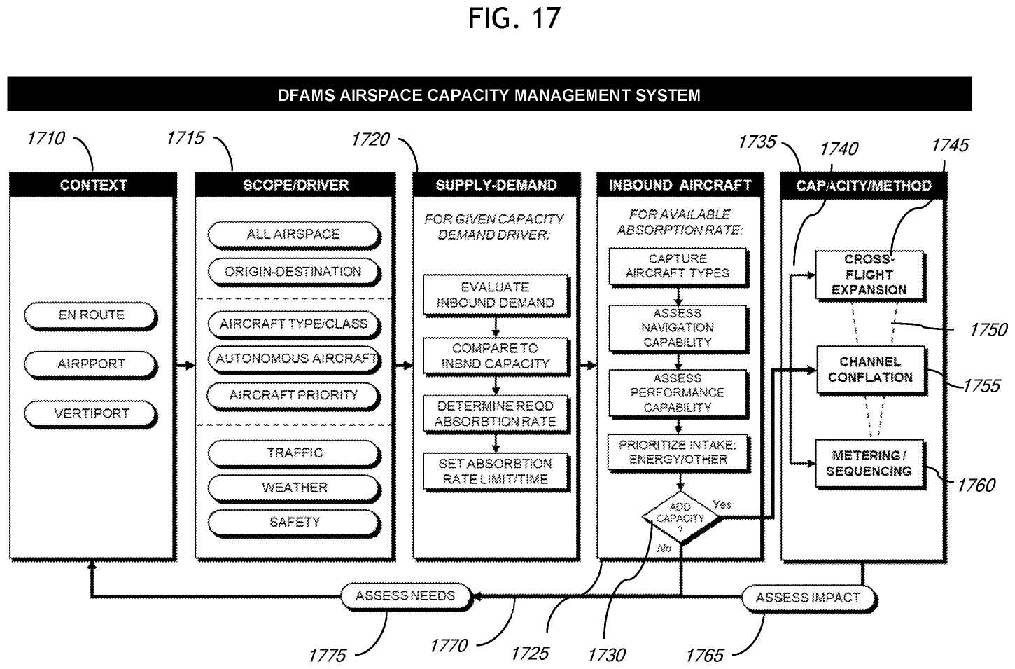

FIG. 17 applies DFAM capabilities to the management of airspace capacity. Specifically, it evaluates the context of capacity needs, the drivers and scope of capacity challenges, the degree to which supply and demand are balanced or not, and the particular nature of the inbound aircraft for which capacity may need to be created. In response to these considerations, capacity is provided, and specific methods of capacity expansion can be selected.

Step one begins with context 1710, and three situations are identified: en route capacity in which the volume of air traffic in a track or information region between airports is addressed, airport capacity in which there is a combination of IFR VFR and DFR aircraft to manage, and the context of a vertiport including a range of autonomous and air taxi vehicles with their unique requirements. Each of these contexts has its own challenges, calling for a further understanding of the scope and drivers of capacity management 1715. Here, an entire airspace embodying multiple destinations is one form of scope as compared to a single origin-destination pair. In addition, drivers of capacity requirements include aircraft type, aircraft priority (for example, for energy concerns), and whether autonomous aircraft without pilots on board are involved. Finally, capacity management is also affected by traffic weather and safety considerations. The balance of capacity supply versus demand 1720 is addressed next and involves the mathematics of inbound demand evaluation, inbound capacity volume, the rate of absorption, and the specific cadence of moving traffic through an airspace or onto an airport, for example. The considerations in 1720 are customary in air traffic capacity management, and are not specific to DFAMS. Consideration of the type and capability of inbound aircraft 1725 and DFAMS ability to manage differential navigation and operating performance can be advantageous in certain capacity management situations as noted in 1725.

After evaluating these considerations, a decision is made at step 1730 to provide additional capacity or not. If the decision is affirmative, then capacity provisioning 1735 is triggered, along with a selection 1740 of the kind of capacity response is appropriate.

To meet the need for increased capacity over a wider expanse of airspace, providing expanded access to cross-flight capacity 1745 is a core tool. Channel conflation 1750 is a responsive approach to adding capacity on specific O-D pairs that does not call for performance-based capabilities. Additionally, adding more channels 1755 to higher-traffic routes can be a selective approach to meeting demand. Performance-based capacity adjustments involve metering and sequencing 1745 traffic to match absorption capability and to prioritize aircraft with higher operating or navigation capabilities as discussed earlier. These methods add capacity in volume and then more selectively as the decreasing funnel 1750 seeks to illustrate.

The anticipated approach to DFR is explicitly reliant on individual operator decisions, skill, and awareness, because it will involve beyond visual line of sight (BVLOS) distances, and since air traffic control does not have the capacity to manage interactions among the expected volume and diversity of individual aircraft. Accordingly, while risk is potentially greater in the DFR environment, it is largely devoid of active regulatory risk management beyond standards, technology, and gradual expansion (NASA's “crawl, walk, run” metaphor).

DFAMS provides an approach to risk management that helps close this gap by enabling a degree of transparency into the most central flight risks: safe separation of aircraft and deconfliction of flight paths. DFAMS's use of airblocks enables designed-in safe separation, protecting especially against lateral and vertical movement that could drift too close to other aircraft (path-aligned separation, PAS). Similarly, DFAMS' channel approach to flight path planning enables each aircraft to reserve and fly a channel that is off limits to other aircraft with the exception of safe cross-flight traffic (channel-based deconfliction, CBD).

These methods are not fool-proof in that they suffer from the same operator-dependent risks as Distributed DFR. However, the airblock and channel engineering of DFAMS enables visibility into the state of both separation and deconfliction that adds a window of opportunity into potential control and avoidance actions. Specifically, the following methods are the core approach to risk management DFAMS enables:
a. Channel-Adherence visibility. DFAMS provides a cross-sectional display of the degree to which all aircraft in flight are adhering to channel boundaries as they proceed along their flight paths. Airblocks already provide for safe separation, and channels connect airblocks across the flight path. A cross-sectional view of all channels combined shows which aircraft, by exception, may be veering too close to a channel wall—posing a risk to separation. This addresses lateral and vertical separation risks in the form of sideways and up/down movement within the channel. Attention only to what is expected to be a limited number of exceptions (those flights at risk of breaching a channel wall) is the basis on which separation risk management across hundreds of concurrent flights becomes a feasible task.
b. Schedule-Adherence visibility. DFAMS also provides a longitudinal display of the degree to which all aircraft in flight are on schedule as they proceed airblock-by-airblock along their channel-based flight paths. Flights that are ahead of schedule may pose a risk to flights in front of them, including cleared cross-flights. Similarly, flights that are behind schedule may pose a risk to trailing direct and cross-flights. Here again, attention only to exceptions (those flights too far ahead or behind schedule) is the basis on which deconfliction risk management across hundreds of concurrent flights becomes a feasible task.
c. Flight Interaction visibility. Visibility into the existence and extent of risk is only useful if there is the opportunity for action, which here requires an ability to alert the specific aircraft operators at risk in sufficient time for corrective action to be taken. DFAMS offers an Interaction Matrix providing visibility into the specific aircraft involved in any potential separation or deconfliction risk scenario, enabling DFAM or the appropriate agency to provide alerts and other assistance directly to operators.

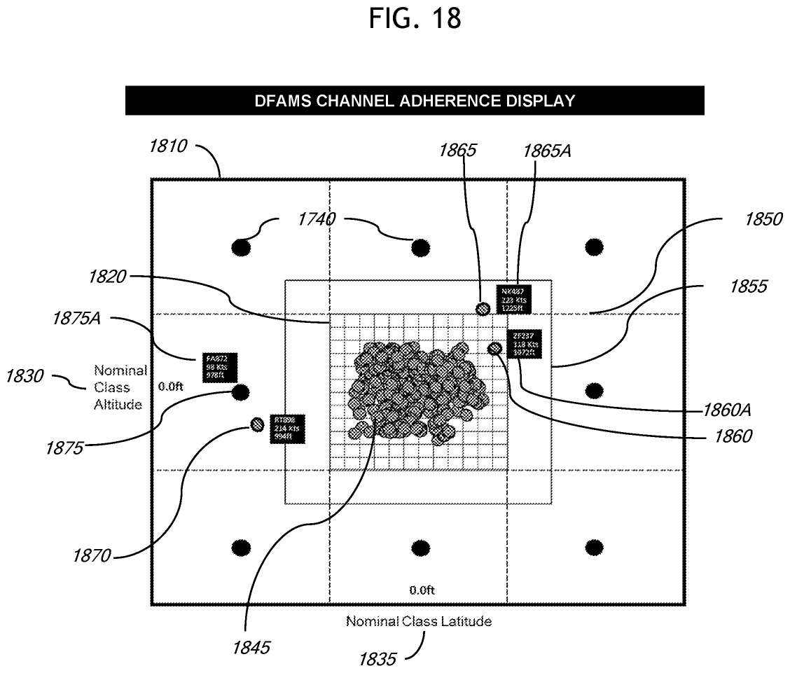

FIG. 18 shows a representative channel-adherence display in accordance with the above discussion. Channel selection 1810 is a collection of all the representative channels surrounding a center channel 1820 which will be our focus for risk management purposes. The respective axes of the display are nominal class altitude 1830 and nominal class latitude 1835, meaning that for any given aircraft, the altitude and latitude may vary, but the display shows them all together for comparative purposes relative to location within the channel. Together, the display shows a group of nine channels with 8 surrounding the center channel, each with a representative aircraft shown as a black dot 1840 identifying the aircraft that would be at risk in the event of a center channel breach.

Center channel 1820 contains a consolidation of the channel cross sections for all in-flight aircraft, wherein all flights are shown together in 1845, each in its actual position for its respective channel. While the dotted lines 1850 around each channel represent the respective channel walls, the perimeter 1855 designates the midpoint between the center channel aircraft and surrounding aircraft, and is the actual point at which an incursion into the space of a surrounding aircraft would occur. (This is the same boundary that becomes relevant to capacity-increasing conflation mentioned earlier.)

FIG. 18 shows several channel breach risks of note. The flight at 1860 is trending toward its channel wall, and as a flight of potential interest, its identifying information is displayed 1860A, including flight ID, airspeed, and current altitude. The flight shown in 1865, and identified 1865A has moved beyond its channel wall, but has not yet breached the boundary 1850 between it and its surrounding channel. However, the flight 1870 has breached both walls, and the flight it is putting at risk the flight at 1875, also highlighted with its identifying information 1875A. By bringing all of these aircraft together with their relative positions shown, the risks from exceptions—potential and actual breaches—can be exposed and addressed, despite the large number of flights under surveillance. In an embodiment, automated triggers and alarms can be programmed to alert controllers to trending and actual breach risks, so that human observers need only to be ready to address either all exceptions or those posing the greatest risks.

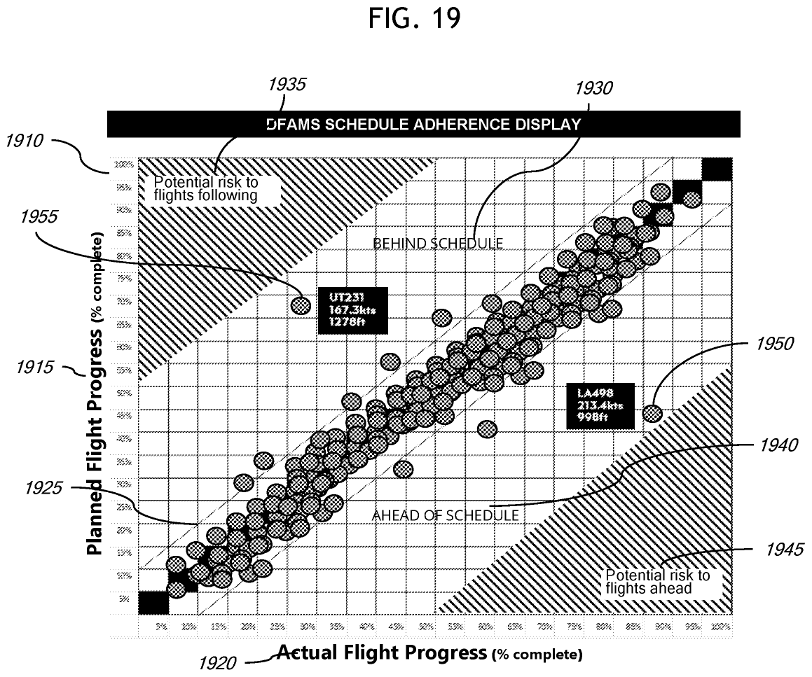

FIG. 19 is a display of schedule adherence, reflecting potential longitudinal risks—safe separation threats to traffic ahead, crossing, or behind any selected flight. The display 1910 portrays the relative schedule position or adherence of all flights under surveillance. The axes of the display show the planned flight progress in percent. The Y axis 1915 shows the flight plan at the time of booking. The X axis 1920 shows actual progress, so that together, the display forms a matched array showing where a given flight is relative to where it was scheduled to be at the time of booking. The center diagonal 1925 forms an alignment matrix, such that any aircraft within a reasonable range of the diagonal is considered to be in adherence with its reserved schedule. Alternatively, aircraft meaningfully above or below the diagonal are respectively, behind or ahead of schedule, with the distance from the diagonal representing the relative gap between planned and actual schedule progress. Flights behind schedule will appear in the zone 1930 above the diagonal. Parameters can be set to highlight particularly high-risk schedule deviations as shown in the risk to following flights sector 1935. Similarly, those flights ahead of schedule are shown in the zone 1940 below the alignment diagonal, with the extreme risks highlighted in 1945.

Two cases highlight both risks to schedule adherence. First is a flight seriously ahead of schedule in 1950, with its identifying information is indicated for tracking purposes. A flight deeply behind schedule is in 1955, with its details shown as well. These flights would be the ones of greatest concern, but all flights outside a variable region around the alignment vector would be under surveillance to track the degree to which the situation may become more concerning over time.

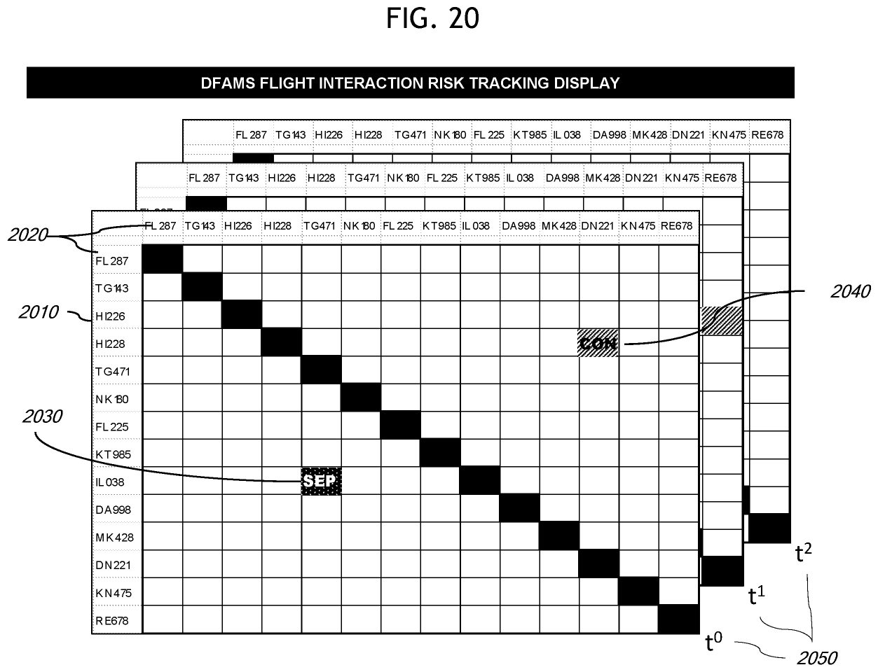

Cases of risk—both schedule and channel—generally involve just two aircraft, and it is critical to identify those specific aircraft and the nature of the risk they are trending toward. FIG. 20 illustrates a flight interaction risk tracking display 2010. It draws from the source displays in FIGS. 18 and 19, but focuses on identifying the highest risk interactions and the specific aircraft involved at a specific point in time. The interaction table axes 2020 show identical listing of all flights on the X and Y axis, such that the null diagonal in the middle reflects the flight's interaction with itself. All the intersections represent unique aircraft interactions. Where the intersections are blank, there are no risks to address as between those two aircraft. However, where there is a risk to separation or deconfliction, it is displayed by the information filled in on the display, such as 2030, which is a separation risk issue (channel breach). All separation issues appear below the null diagonal, and conflict risks (schedule compression) are shown above the diagonal, such as 2040. Importantly, the display cycles with a cadence tied to the time frame for effective surveillance—possibly every 5 seconds for example, yielding a series of interaction displays 2050 with different slices of time t, with the most recent shown on an operator's current display screen.

A number of variations to this display can be envisioned. For example, color codes might be used to reflect the degree of risk over time. Additional panels can be added to provide information in a window on this display, including bringing the channel and schedule risk data into a window to more effectively visualize the full context of the changing risks. Magnification could also be applied to better zero-in on specific details, and the actual intersection cells could be made into clickable buttons that bring up intelligent windows providing additional information about the risk being examined. Moreover, in an embodiment, automation can be applied to the interaction display as well, providing alerts for any risk situation, and with tolerances and risk setting able to be varied with circumstances, aircraft type and speed, or other criteria. In addition to automatically showing a type of risk meeting certain criteria for attention, the moving trajectories of the two aircraft could be shown (from earlier recorded frames, for example). The risk oversight team could be alerted in specific instances, and based on the inherent risk, an automated warning could be issued to each aircraft by the DFAM system itself, for example, based on artificial intelligence computation of projected risks. Operating in real time, the system could also generate options, select options, and execute messaging when the system determined there may be insufficient time to wait for human response. This would be equivalent to the manner in which the combat operations center of an aircraft carrier takes over from human operators when the number of incoming threats would overwhelm the human operators' ability to prioritize and respond in time.

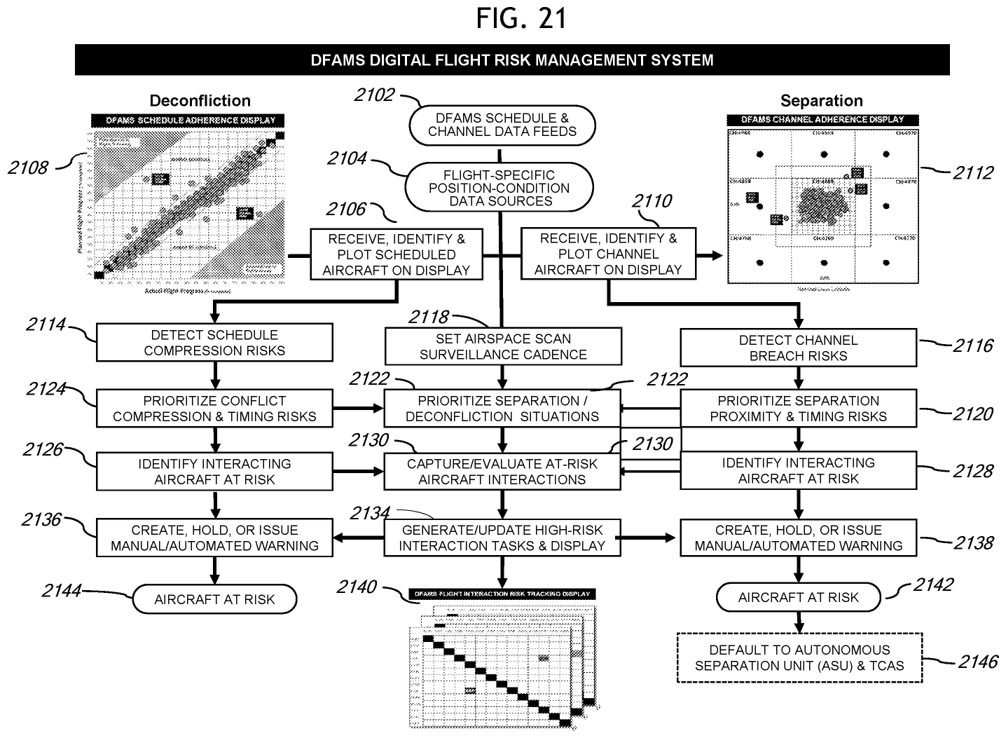

Turning to FIG. 21, a digital flight risk management system based on the DFAMS is illustrated. The system incorporates and leverages the schedule adherence display 2108, the channel adherence display 2112 and the resulting interaction risk display 2140 which is a basis for taking operator-led action in addition to the automated functionality also available 2136 and 2138. The following steps create and operate the DFAMS Risk Management system.

Step 2102 and Step 2104 set up the incoming system feeds from DFAMS schedule and channel status, and from flight-specific position-condition data sources, respectively. The latter include National Airspace System data as well as PSU and SDSP (respectively, Provider of Services to UAMs, and Supplemental Data Services Provider) source data described in FIG. 2, DFAMS Communications Architecture. This information is received in display processors 2106 and 2110, and projected to displays 2108 and 2112.

Steps 2114 and 2116 process the received information to detect risks from schedule compression and channel breach, respectively. Step 2118 sets the cycle time for the interaction risk display, so it polls and displays risk data at a rate consistent with the rate of change of flight activity and risk events. This cycle time can automatically respond to increased flight activity as well as to increased event frequency to enable adequate notice of potential risks, and to enable review by operators and to support decision-making. Both the system and the operator work on prioritizing separation and deconfliction risks 2120 and 2124, first separately and then jointly 2122 to determine how to proceed. After zeroing-in on prioritized risks, the specific aircraft involved are identified 2126, 2128, and the combined data are evaluated using automation as well as operator experience in step 2130.

The process of joint review, including automation, artificial intelligence, and machine learning results in updates 2134 that inform the nature of the response to identified risks, including composition and dissemination of any warning messages to be issued 2136, 2138 to aircraft at risk. As warranted, those messages can be issued automatically, manually, or held until certain risk thresholds are exceeded. The interaction display 2140 is updated with appropriate imaging and notations, and as determined by operators or system overrides, specific aircraft at risk are notified 2142, 2144. Messaging is created, held, or issued as appropriate 2142, 2144 and the interaction display, where individual aircraft are targeted, is updated to track risks and determine the appropriate response.

In an embodiment, where the DFAMS risk management system cannot respond quickly enough to pending risks, there is an opportunity to avert critical risks through the application of autonomous separation unit (ASU) technology to enable aircraft to spontaneously move away from each other and establish separation automatically or with operator intervention. The ASU functionality operates beyond the range of standard traffic collision avoidance systems (TCAS) which responds to relative imminence of collision.

Herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

1. A method for managing the flight of an aircraft through an airspace from an origin to a destination, the aircraft being of a particular class having predetermined safe separation parameters for the particular class of the aircraft, the airspace being defined in a database as a 3D lattice of airblocks, each airblock having an entry in the database and having fields including at least: (i) spatial coordinates of the airblock, (ii) dimensions of the airblock based upon the safe separation parameters for the particular class of the aircraft, and (iii) an availability state of the airblock as a function of time, the method comprising the steps:
receiving a request from a user to reserve a flight plan for the aircraft from the origin to the destination for a specified timeframe,
identifying a flight channel comprising at least one set of contiguous airblocks within the airspace extending from the origin to the destination which (i) are available during the timeframe for the requested flight plan, and (ii) have permitted aircraft classes that correspond to the class of the aircraft,
reserving for at least a portion of the flight plan timeframe, each of the airblocks comprising the identified flight channel by changing the availability status of each of the airblocks to unavailable during the relevant time of the flight plan,
communicating to the user that the requested flight plan has been reserved, together with information regarding the channel of airblocks for the flight, and
during the flight of the aircraft, continuously performing the following steps:
receiving information regarding the position of the aircraft during the flight timeframe,
comparing the current position of the aircraft to the position of the flight channel airblock corresponding to the relevant time of the flight,
transmitting to the aircraft updated information regarding whether the position of the aircraft corresponds to or deviates from the flight channel airblock corresponding to the relevant time of the flight.

2. The method according to claim 1 wherein the aircraft is one of an airplane, a helicopter, an air taxi, and a vertical take-off-and-landing aircraft.

3. The method according to claim 1 wherein the entry in the database for each of the airblocks in the shared airspace further includes a field relating at least one of (i) forecasted weather conditions for the airblock as a function of time, (ii) an obstruction within the airblock, (iii) a restriction within the airblock, and (iv) air traffic as a function of time.

4. The method according to claim 1 wherein the airspace is further organized into at least two aircraft class layers, and the airblock dimensions for the airblocks in a first class layer are larger than the airblock dimensions in the second class layer.

5. The method according to claim 4 where the airblocks in the first class layer are at an altitude higher than the airblocks in the second class layer.

6. The method according to claim 1 wherein the identifying step further comprises presenting to the user a plurality of available flight channels corresponding to the origin and destination from which the user can select one in connection with the identifying step.

7. The method according to claim 1 wherein, during the flight of the aircraft, the status of each airblock is changed to available when the aircraft has moved through the airblock.

8. A method for managing the flight of an autonomous air taxi through a shared airspace from an origin to a destination, the air taxi having predetermined safe separation parameters, the method comprising the steps:
defining the airspace as a database representing a 3D lattice of airblocks, each airblock having an entry in the database and having fields including at least: (i) spatial coordinates of the airblock, (ii) dimensions of the airblock based upon the safe separation parameters for the air taxi, and (iii) an availability state of the airblock as a function of time,
identifying a flight plan for the air taxi from the origin to the destination for a specified timeframe,
identifying a flight channel of contiguous airblocks within the airspace extending from the origin to the destination having a state of “available” during the timeframe for the flight plan,
reserving the identified flight channel by changing the state to “unavailable” for each of the airblocks comprising the identified flight channel during the relevant time of the flight plan,
communicating to the air taxi the identified flight plan and the reserved flight channel including the set of airblocks comprising the reserved flight channel,
during the flight of the air taxi, continuously monitoring the current position of the air taxi with respect to the airblock in the reserved flight channel for the air taxi during the relevant time of the flight,
if the current position of the air taxi differs from the position of the airblock in the reserved flight channel for the air taxi during the relevant time of the flight, identifying and reserving an updated flight channel from the current position of the air taxi to the destination, and communicating to the air taxi with the updated reserved flight channel information.

9. The method according to claim 8 where the entry in the database for each of the airblocks in the shared airspace further includes a field relating to at least one of (i) forecasted weather conditions for the airblock as a function of time, (ii) an obstruction within the airblock, (ii) a restriction within the airblock, and (iv) air traffic as a function of time.

10. The method according to claim 8 wherein the step of identifying a flight channel includes presenting a user with a plurality of flight channels of contiguous available airblocks from the origin to the destination, and one of the plurality of airblocks is selected by a user.

11. The method according to claim 10 wherein at least one of the presented plurality of flight channels is designated as a flight channel with better fuel efficiency for the flight plan.

12. The method according to claim 10 wherein at least one of the presented plurality of flight channels is designated as a flight channel with reduced flight time for the flight plan.

13. The method according to claim 10 wherein at least one of the presented plurality of flight channels is designated as a flight channel with better emissions for the flight plan.

14. The method according to claim 8 wherein, during the flight of the air taxi, the state of each airblock is changed to available when the air taxi has moved through the airblock.

15. An airspace configuration and management system for accommodating a plurality of flight plans in the airspace for a plurality of aircraft, the system including an electronic data processor, electronic data memory, electronic data storage, and a plurality of communication interfaces, the system configured to comprise:
(a) an airblock configuration and management module which defines and stores the airspace in a database as a 3D lattice of airblocks, each airblock having an entry in the database and having fields including at least: (i) spatial coordinates of the airblock, (ii) dimensions of the airblock, and (ii) a state of the airblock as a function of time, which includes at least the states of “available” and “unavailable,”
(b) a flight channel identification and reservation module which: (i) receives a request from a user to reserve a flight plan for an aircraft from an origin to a destination in the airspace for a specified timeframe, (ii) identifying at least one flight channel comprising a set of contiguous airblocks within the airspace extending from the origin to the destination which have a state of “available” during the timeframe for the requested flight plan, (iii) reserving the requested flight plan by changing the state of the set of airblocks to “unavailable” for the relevant time of the flight plan, and (iv) communicating to the user that the requested flight plan has been reserved, together with information regarding the channel of reserved airblocks corresponding to the flight plan, and
(c) a flight communication and management module which (i) receives information regarding the position of the aircraft during the flight timeframe, (ii) compares the current position of the aircraft to the position of the airblock corresponding to the relevant time of the flight, and (iii) continuously communicates to the aircraft during the flight information regarding the comparison.

16. The system according to claim 15 wherein the airblock configuration and management module further organizes the airspace into at least two aircraft class layers, and the airblock dimensions for the airblocks in a first class layer are larger than the airblock dimensions for the airblocks in a second class layer.

17. The system of claim 16 wherein the plurality of aircraft fall into one of the at least two aircraft classes, and the aircraft in a first class are authorized to use airblocks in the first class layer and the aircraft in a second class are authorized to use airblocks in the second class layer.

18. The system of claim 17 wherein the dimensions of the airblocks in the first class layer correspond to the safe separation parameters of the first class of aircraft and the dimensions of the airblocks in the second class layer correspond to the safe separation parameters of the second class of aircraft.

19. The system of claim 15 further comprising a capacity management module which performs a conflation operation to safely increase the volume of aircraft utilizing the airspace at the same timeframe by partially overlapping the boundaries of airblocks of reserved channels for aircraft with flight plans for traveling in parallel directions in adjacent channels during the same timeframe.

20. The system of claim 15 further comprising a capacity management module which adjusts the longitudinal or lateral spacing of aircraft in a plurality of channels to change the volume or quantity of aircraft flowing through the relevant channels.
